(19) United States
(12) Patent Application Publication
(10) Pub. No.: US 2026/0119178 A1
(43) Pub. Date: Apr. 30, 2026

(54) TRANSMISSION SYSTEM AND TRANSMISSION DEVICE

(71) Applicant: Fujitsu Limited, Kawasaki-shi (JP)

(72) Inventors: Ichiro YOKOKURA, Sano (JP); Yusuke TANABE, Sendai (JP); Junichi SUGIYAMA, Kawasaki (JP)

(73) Assignee: Fujitsu Limited, Kawasaki-shi (JP)

(21) Appl. No.: 19/373,348

(22) Filed: Oct. 29, 2025

(30) Foreign Application Priority Data
Oct. 31, 2024 (JP) 2024-192441

(51) Int. Cl. G06F 9/38; G06F 9/48

(52) U.S. Cl. CPC G06F 9/3854; G06F 9/4812

(57) ABSTRACT

A transmission system includes a control device configured to issue a command including at least one processing request, a processing device configured to execute respective processing corresponding to each processing request in the command, and a transmission device configured to communicate between the control device and the processing device. The processing device is configured to, upon executing the processing corresponding to the processing request among a plurality of processing requests in the command, notify the transmission device of completion of processing for the processing request. The transmission device is configured to, upon receiving the completion of processing corresponding to a final processing request among the plurality of processing requests in the command, notify the control device of completion of execution for the command.

### CROSS-REFERENCE TO RELATED APPLICATION

This application is based upon and claims the benefit of priority of the prior Japanese Patent Application No. 2024-192441, filed on Oct. 31, 2024, the entire contents of which are incorporated herein by reference.

### FIELD

The embodiments discussed herein are related to transmission systems and transmission devices.

### BACKGROUND

In data communications within a data center, a protocol known as non-volatile memory express (NVMe) is being used, for example, for high-speed access by a central processing unit (CPU) within a compute server to a high-bandwidth solid-state drive (SSD) storage.

Further, another known implementation of NVMe is NVMe-over-fabric (NVMe-oF), which is an extension of NVMe, to achieve faster and more efficient data communications between compute servers and storage servers. The NVMe-oF enables data communications across fabrics such as L2SW by encapsulating data using, for example, the Ethernet (registered trademark) or Infini-Band protocols. Examples of NVMe-oF data communications include NVMe-over-RDMA, which uses the remote direct memory access (RDMA) protocol. Additionally, in NVMe-oF processing, it is known to offload the network control processing, originally performed by the host CPU on the compute server, to a smart network interface card (smart NIC), thereby reducing the load on the host CPU.

In a transmission system employing NVMe-oF, queue-based management and control are performed between the host CPU within the compute server and the NVMe controller within the storage server, arbitrating performance differences among processing units and ensuring ordering and reachability. The host CPU includes Admin used to control the NVMe controller and I/O used to transfer data, each of which is assigned one or more submission queues (SQs) and completion queues (CQs). The SQ is, for example, a circular buffer in which the host CPU queues processing requests issued to the NVMe controller. Moreover, the CQ is a circular buffer that queues processing completion flags indicating the completion of processing requests. The NVMe controller also has Admin and I/O functionalities, each of which is assigned one or more SQs/CQs.

Patent Literature 1: Japanese Laid-open Patent Publication No. 2002-163239

Patent Literature 2: Japanese Laid-open Patent Publication No. 2005-122236

Patent Literature 3: U.S. Patent Application Publication No. 2004/0260856

In a transmission system employing NVMe-oF, the distance between the compute server and the storage server is, for example, a short distance of approximately 1 km. However, in transmission systems within data centers, where lower latency and reduced power consumption are increasingly demanded, the practical implementation of optical transmission and co-packaged optics (CPO) is also being considered, and long-distance transmission between data centers using optical transmission L1 frames is also being regarded as a future demand. Thus, an NVMe-oF transmission system capable of long-distance transmission, such as over a distance of approximately 1200 km between a compute server and a storage server, is considered to be desirable in practice.

### SUMMARY

According to an aspect of an embodiment, a transmission system includes a control device configured to issue a command including at least one processing request, a processing device configured to execute respective processing corresponding to each processing request in the command, and a transmission device configured to communicate between the control device and the processing device. The processing device is configured to, upon executing the processing corresponding to the processing request among a plurality of processing requests in the command, notify the transmission device of completion of processing for the processing request. The transmission device is configured to, upon receiving the completion of processing corresponding to a final processing request among the plurality of processing requests in the command, notify the control device of completion of execution for the command.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrated to describe an exemplary optical transmission system according to a first embodiment;

FIG. 2 is a diagram illustrated to describe an example of a first smart NIC and a second smart NIC used in the optical transmission system according to the first embodiment;

FIG. 3 is a diagram illustrated to describe an exemplary processing operation regarding parallel distributed processing in the optical transmission system according to the first embodiment;

FIG. 4 is a sequence diagram illustrating an exemplary processing operation regarding preprocessing in the optical transmission system according to the first embodiment;

FIG. 5 is a sequence diagram illustrating an exemplary processing operation regarding a first write-processing operation in the optical transmission system according to the first embodiment;

FIG. 6 is a sequence diagram illustrating an exemplary processing operation regarding the first write-processing operation in the optical transmission system according to the first embodiment;

FIG. 7 is a sequence diagram illustrating an exemplary processing operation regarding the first write-processing operation in the optical transmission system according to the first embodiment;

FIG. 8 is a sequence diagram illustrating an exemplary processing operation regarding the first write-processing operation in the optical transmission system according to the first embodiment;

FIG. 9 is a sequence diagram illustrating an exemplary processing operation regarding data roll-up processing in the optical transmission system according to the first embodiment;

FIG. 10 is a flowchart illustrating an exemplary processing operation of a first offload control unit regarding a first determination processing;

FIG. 11 is a flowchart illustrating an exemplary processing operation of the first offload control unit regarding a second determination processing;

FIG. 12 is a sequence diagram illustrating an exemplary processing operation regarding a second write-processing operation in an optical transmission system according to a second embodiment;

FIG. 13 is a sequence diagram illustrating an exemplary processing operation regarding the second write-processing operation in the optical transmission system according to the second embodiment;

FIG. 14 is a sequence diagram illustrating an exemplary processing operation regarding the second write-processing operation in the optical transmission system according to the second embodiment;

FIG. 15 is a sequence diagram illustrating an exemplary processing operation regarding the second write-processing operation in the optical transmission system according to the second embodiment;

FIG. 16 is a flowchart illustrating an exemplary processing operation regarding third determination processing in a second offload control unit;

FIG. 17 is a flowchart illustrating an exemplary processing operation regarding fourth determination processing in the first offload control unit;

FIG. 18 is a diagram illustrated to describe an exemplary processing operation regarding pipeline-type distributed processing in the optical transmission system according to a third embodiment;

FIG. 19 is a sequence diagram illustrating an exemplary processing operation regarding preprocessing in the optical transmission system according to the third embodiment;

FIG. 20 is a sequence diagram illustrating an exemplary processing operation regarding a third write-processing operation in the optical transmission system according to the third embodiment;

FIG. 21 is a sequence diagram illustrating an exemplary processing operation regarding the third write-processing operation in the optical transmission system according to the third embodiment;

FIG. 22 is a sequence diagram illustrating an exemplary processing operation regarding the third write-processing operation in the optical transmission system according to the third embodiment;

FIG. 23 is a sequence diagram illustrating an exemplary processing operation regarding the third write-processing operation in the optical transmission system according to the third embodiment;

FIG. 24 is a sequence diagram illustrating an exemplary processing operation regarding a fourth write-processing operation in the optical transmission system according to a fourth embodiment;

FIG. 25 is a sequence diagram illustrating an exemplary processing operation regarding the fourth write-processing operation in the optical transmission system according to the fourth embodiment;

FIG. 26 is a sequence diagram illustrating an exemplary processing operation regarding the fourth write-processing operation in the optical transmission system according to the fourth embodiment;

FIG. 27 is a sequence diagram illustrating an exemplary processing operation regarding the fourth write-processing operation in the optical transmission system according to the fourth embodiment;

FIG. 28 is a diagram illustrated to describe an example of an instruction source CPU and an instruction destination CPU according to another embodiment;

FIG. 29 is a diagram illustrated to describe an example of an instruction source CPU and an instruction destination CPU according to another embodiment;

FIG. 30 is a diagram illustrated to describe an exemplary optical transmission system according to a first comparative example;

FIG. 31 is a diagram illustrated to describe an example of a third smart NIC and a fourth smart NIC used in the optical transmission system according to the first comparative example;

FIG. 32 is a sequence diagram illustrating an exemplary processing operation regarding a write-processing operation in the optical transmission system according to the first comparative example;

FIG. 33 is a sequence diagram illustrating an exemplary processing operation regarding the write-processing operation in the optical transmission system according to the first comparative example;

FIG. 34 is a diagram illustrated to describe an exemplary optical transmission system according to a fifth embodiment;

FIG. 35 is a diagram illustrated to describe an example of a fifth smart NIC and a sixth smart NIC used in the optical transmission system according to the fifth embodiment;

FIG. 36 is a sequence diagram illustrating an exemplary processing operation regarding a write-processing operation in the optical transmission system according to the fifth embodiment;

FIG. 37 is a sequence diagram illustrating an exemplary processing operation regarding the write-processing operation in the optical transmission system according to the fifth embodiment;

FIG. 38 is a diagram illustrated to describe an exemplary optical transmission system according to a sixth embodiment;

FIG. 39 is a diagram illustrated to describe an exemplary processing operation regarding parallel distributed processing in the optical transmission system according to the sixth embodiment;

FIG. 40 is a sequence diagram illustrating an exemplary processing operation regarding preprocessing in the optical transmission system according to the sixth embodiment; and

FIG. 41 is a sequence diagram illustrating an exemplary processing operation regarding a write-processing operation and data roll-up processing in the optical transmission system according to the sixth embodiment.

### DESCRIPTION OF EMBODIMENTS

### (a) First Comparative Example

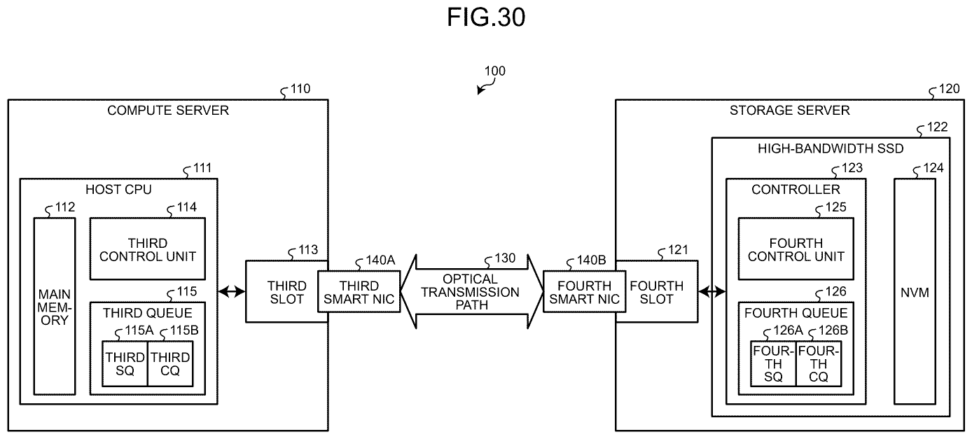

An optical transmission system 100 according to a first comparative example, which implements long-distance transmission between data centers, is described. FIG. 30 is a diagram illustrated to describe an example of the optical transmission system 100 according to the first comparative example. The optical transmission system 100 illustrated in FIG. 30 includes a compute server 110, a storage server 120, and an optical transmission path 130 that communicatively connects the compute server 110 and the storage server 120. The compute server 110 is a server that includes a host central processing unit (CPU) 111 and a third slot 113.

The host CPU 111 controls the overall operation of the compute server 110. The host CPU 111 includes a main memory 112, a third control unit 114 that controls the main memory 112, and a third queue 115 used for the NVMe-oF protocol. The main memory 112 is, for example, a double data rate (DDR) memory that stores data. The third queue 115 includes a third submission queue (SQ) 115A and a third completion queue (CQ) 115B. The third SQ 115A is, for example, a circular buffer on the compute server 110 side that queues NVMe-oF protocol processing requests issued by the host CPU 111 to a controller 123. The third CQ 115B is, for example, a circular buffer on the compute server 110 side that queues processing completion flags indicating the completion of processing of the processing requests.

The optical transmission path 130 is, for example, an optical transmission path using wavelength division multiplexing (WDM) in an optical transport network (OTN) that connects the compute server 110 and the storage server 120 for communication. The third slot 113 is, for example, a peripheral component interconnect express (PCIe) slot that connects with a third smart network interface card (smart NIC) 140A. The third smart NIC 140A is a NIC configured to enable communication using the NVMe-oF protocol over an optical transmission Layer 1 frame.

The storage server 120 is a counterpart device to the compute server, and includes a fourth slot 121 and a high-bandwidth SSD (Solid State Drive) 122. The high-bandwidth SSD 122 controls the overall operation of the storage server 120. The high-bandwidth SSD 122 includes a controller 123 and a non-volatile memory (NVM) 124. The controller 123 controls the overall operation of the high-bandwidth SSD 122. The controller 123 includes a fourth control unit 125 that controls the NVM 124 and a fourth queue 126 used for the NVMe-oF protocol. The fourth queue 126 includes a fourth SQ 126A and a fourth CQ 126B. The fourth SQ 126A is, for example, a circular buffer on the storage server 120 side that queues NVMe-oF protocol processing requests transferred from the host CPU 111. Additionally, the fourth CQ 126B is a circular buffer on the storage server 120 side that queues real acknowledgments (real ACKs) indicating the completion of processing of the processing requests. The NVM 124 is a non-volatile secondary storage device that stores data.

The fourth slot 121 is a PCIe slot that connects to a fourth smart NIC 140B. The fourth smart NIC 140B is a NIC configured to enable communication using the NVMe-oF protocol over an optical transmission Layer 1 frame.

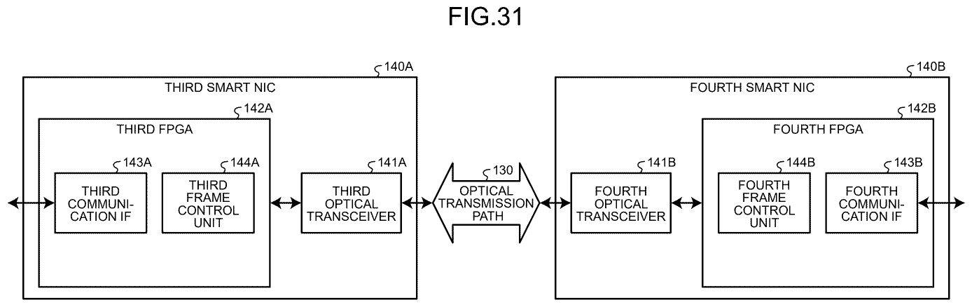

FIG. 31 is a diagram illustrated to describe an example of the third smart NIC 140A and the fourth smart NIC 140B used in the optical transmission system 100 of the first comparative example. The third smart NIC 140A includes a third optical transceiver 141A and a third field-programmable gate array (FPGA) 142A. The third optical transceiver 141A is an optical transceiver equipped with optical-to-electrical conversion functionality that performs optical transmission and reception with the optical transmission path 130. The third FPGA 142A includes a third communication interface (IF) 143A and a third frame control unit 144A. The third communication IF 143A is a communication IF that communicates with the third slot 113. The third frame control unit 144A is a signal processing unit that encapsulates (assembles) or decapsulates (disassembles) a signal into or from the optical transmission Layer 1 frame for communication with the optical transmission path 130.

The fourth smart NIC 140B includes a fourth optical transceiver 141B and a fourth FPGA 142B. The fourth optical transceiver 141B is an optical transceiver equipped with optical-to-electrical conversion functionality for performing optical transmission and reception with the optical transmission path 130. The fourth FPGA 142B includes a fourth communication IF 143B and a fourth frame control unit 144B. The fourth communication IF 143B is a communication IF that communicates with the fourth slot 121. The fourth frame control unit 144B is a signal processing unit that encapsulates or decapsulates a signal into or from the optical transmission Layer 1 frame for communication with the optical transmission path 130.

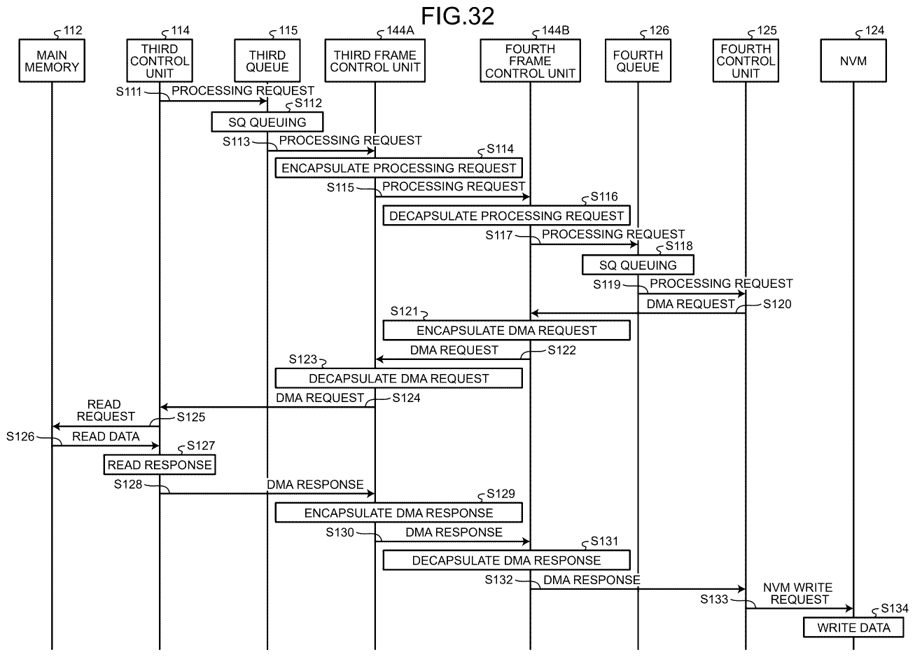

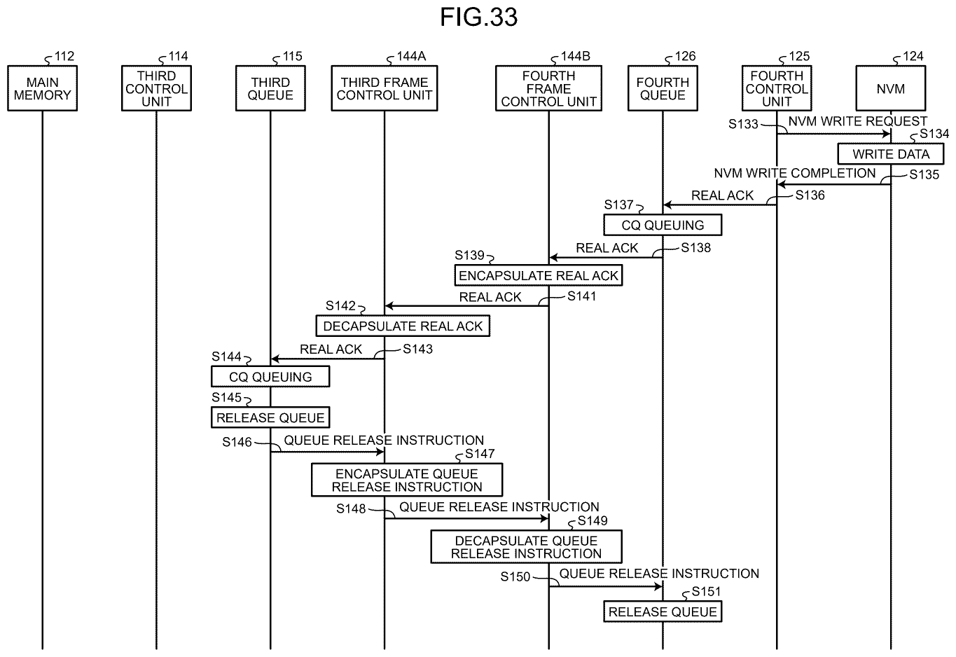

FIGS. 32 and 33 are sequence diagrams illustrating an example of the processing operation regarding the write-processing operation in the optical transmission system 100 according to the first comparative example. The third control unit 114 in the host CPU 111 issues a processing request of the NVMe-oF protocol, for example, a processing request to write the write-target data that is stored in the main memory 112 into the NVM 124. The third control unit 114 notifies the third queue 115 of the issued processing request (step S111). The third SQ 115A in the third queue 115 performs SQ queuing of the notified processing request (step S112).

The third frame control unit 144A in the third smart NIC 140A detects the processing request queued in the third SQ 115A in accordance with the doorbell function of the third queue 115 (step S113) and encapsulates the detected processing request (step S114). The third frame control unit 144A optically converts the encapsulated processing request via the third optical transceiver 141A and transmits the optically converted processing request to the fourth smart NIC 140B of the storage server 120 through the optical transmission path 130 (step S115).

The fourth frame control unit 144B in the fourth smart NIC 140B electrically converts the encapsulated processing request via the fourth optical transceiver 141B, and decapsulates the electrically converted processing request (step S116). Then, the fourth frame control unit 144B notifies the fourth queue 126 in the controller 123 of the decapsulated processing request (step S117). The fourth SQ 126A in the fourth queue 126 performs SQ queuing of the notified processing request (step S118).

The fourth control unit 125 in the controller 123 detects a processing request queued in the fourth SQ 126A in accordance with the doorbell function of the fourth queue 126 (step S119). The fourth control unit 125 notifies the fourth frame control unit 144B of a direct memory access (DMA) request in response to the detected processing request (step S120). The fourth frame control unit 144B encapsulates the DMA request (step S121). The fourth frame control unit 144B optically converts the DMA request via the fourth optical transceiver 141B, and transmits the encapsulated and optically converted DMA request to the third smart NIC 140A through the optical transmission path 130 (step S122).

The third frame control unit 144A in the third smart NIC 140A electrically converts the encapsulated DMA request via the third optical transceiver 141A and decapsulates the electrically converted DMA request (step S123). Then, the third frame control unit 144A notifies the third control unit 114 in the host CPU 111 of the decapsulated DMA request (step S124). The third control unit 114, in response to the DMA request, issues a read request to the main memory 112 (step S125). The main memory 112 reads the write-target data in response to the read request (step S126) and sends a read response including the read write-target data to the third control unit 114 (step S127).

The third control unit 114, upon detecting the read response, notifies the third frame control unit 144A of a DMA response that includes the read write-target data (step S128). The third frame control unit 144A encapsulates the DMA response (step S129). The third frame control unit 144A optically converts the encapsulated DMA response via the third optical transceiver 141A and optically transmits the optically converted DMA response to the fourth smart NIC 140B through the optical transmission path 130 (step S130).

The fourth frame control unit 144B in the fourth smart NIC 140B electrically converts the encapsulated DMA response via the fourth optical transceiver 141B and decapsulates the electrically converted DMA response (step S131). The fourth frame control unit 144B notifies the fourth control unit 125 of the decapsulated DMA response (step S132). In response to the DMA response, the fourth control unit 125 issues, to the NVM 124, an NVM write request to write the write-target data in the DMA response into the NVM 124 (step S133).

The NVM 124 writes the write-target data in response to the NVM write request (step S134) and notifies the fourth control unit 125 of NVM write completion indicating completion of the write (step S135). The fourth control unit 125, upon detecting the completion of the NVM write, notifies the fourth queue 126 of a real ACK indicating the completion of processing of the processing request (step S136). The fourth CQ 126B in the fourth queue 126 performs CQ queuing of the notified real ACK (step S137).

The fourth frame control unit 144B detects the real ACK stored in the fourth CQ 126B in accordance with the doorbell function of the fourth queue 126 (step S138). The fourth frame control unit 144B encapsulates the real ACK (step S139). The fourth frame control unit 144B optically converts the encapsulated real ACK via the fourth optical transceiver 141B (step S140) and optically transmits the optically converted real ACK to the third smart NIC 140A through the optical transmission path 130 (step S141).

The third frame control unit 144A in the third smart NIC 140A electrically converts the encapsulated real ACK via the third optical transceiver 141A and decapsulates the electrically converted real ACK (step S142). Then, the third frame control unit 144A notifies the third queue 115 in the host CPU 111 of the decapsulated real ACK (step S143).

The third CQ 115B in the third queue 115 performs CQ queuing of the notified real ACK (step S144). The third queue 115 releases the information regarding the target SQ/CQ pair (step S145) and notifies the third frame control unit 144A of a queue release instruction to release the queue of the fourth queue 126 (step S146). The third frame control unit 144A encapsulates the queue release instruction (step S147). The third frame control unit 144A optically converts the encapsulated queue release instruction via the third optical transceiver 141A and optically transmits the optically converted queue release instruction to the fourth smart NIC 140B through the optical transmission path 130 (step S148).

The fourth frame control unit 144B in the fourth smart NIC 140B electrically converts the encapsulated queue release instruction via the fourth optical transceiver 141B and decapsulates the electrically converted queue release instruction (step S149). Then, the fourth frame control unit 144B notifies the fourth CQ 126B in the controller 123 of the decapsulated queue release instruction (step S150). The fourth queue 126 releases the information regarding the target SQ/CQ pair (step S151), thereby completing the processing operation illustrated in FIG. 33.

In the write processing operation, a total of five handshakes is performed, including the processing request in step S115, the DMA request in step S122, the DMA response in step S130, the real ACK in step S141, and the queue release instruction in step S148, during each of which transmission latency occurs. In other words, assuming a transmission latency of t for one handshake between the compute server 110 and the storage server 120, the total transmission latency due to handshaking from the issuance of a single processing request to the completion of execution of the processing request becomes 5t.

In other words, in the case where the optical transmission system 100 of the first comparative example is applied to long-distance optical transmission, a transmission latency of 5t due to the handshake between the compute server 110 and the storage server 120 occurs. This transmission latency is included in the processing time and becomes the dominant factor, resulting in persistent queue congestion and significantly reduced throughput. Moreover, although mitigating the queue congestion might be possible by equipping the host CPU 111 and the controller 123 with a large number of CPU cores to distribute the processing load, such an approach would significantly increase component costs.

Furthermore, the following describes the results of a comparison of throughput between a short-distance NVMe-oF transmission system for short-distance applications and a transmission system employing NVMe-oF for long-distance applications. In the short-distance transmission system using NVMe-oF for short-distance applications, the transmission distance between the compute server and the storage server is set to 1 km, the processing time per processing request entry is 300 ns, and the amount of data processed per entry is 4 KB. Furthermore, in the short-distance transmission system, it is assumed that the data processing throughput per entry is 109 Gbps, the processing time per entry until queue release is 25 μs, and the number of CPU cores is 1. In this case, the throughput of the short-distance transmission system is approximately 109 Gbps.

In the optical transmission system 100 of the first comparative example, which applies NVMe-oF for long-distance transmission and employs a single-core CPU, the transmission distance between the compute server 110 and the storage server 120 is set to 1200 km, and the processing time per entry is set to 300 ns. Furthermore, in the optical transmission system 100, it is assumed that the amount of data processed per entry is 4 KB, the data processing throughput per entry is 109 Gbps, the processing time per entry until queue release is 30 ms, and the number of CPU cores is one. The throughput of the optical transmission system 100 of the first comparative example is approximately 1 Gbps. This demonstrates that, due to transmission latency, the throughput of the optical transmission system 100 of the first comparative example is significantly lower than the throughput of the short-distance transmission system.

In contrast, in an optical transmission system implementing NVMe-oF for long-distance transmission and employing a multi-core CPU, the transmission distance between the compute server 110 and the storage server 120 is also set to 1200 km, and the processing time per entry is set to 300 ns. Furthermore, in the optical transmission system described above, it is assumed that the amount of data processed per entry is 4 KB, the data processing throughput per entry is 109 Gbps, the processing time until queue release per entry is 30 ms, and the number of CPU cores is 30. The throughput of the optical transmission system described above reaches approximately 109 Gbps because the processing load is distributed among the multiple cores.

In other words, in the optical transmission system 100 according to the first comparative example, which applies NVMe-oF for long-distance transmission and uses a single-core CPU, it demonstrates that the throughput is significantly reduced during long-distance transmission due to transmission latency caused by the handshake. Thus, although the increase in the number of CPU cores improves throughput, this leads to a substantial increase in component costs. Accordingly, there is a demand for an NVMe-oF optical transmission system suitable for long-distance transmission that is capable of improving throughput without increasing the number of CPU cores. Thus, the present applicant provides an optical transmission system according to a fifth embodiment. Note that the disclosed technology is not limited to the embodiments provided herein. Furthermore, the respective embodiments described below may also be appropriately combined, provided there is no inconsistency.

### (b) Fifth Embodiment

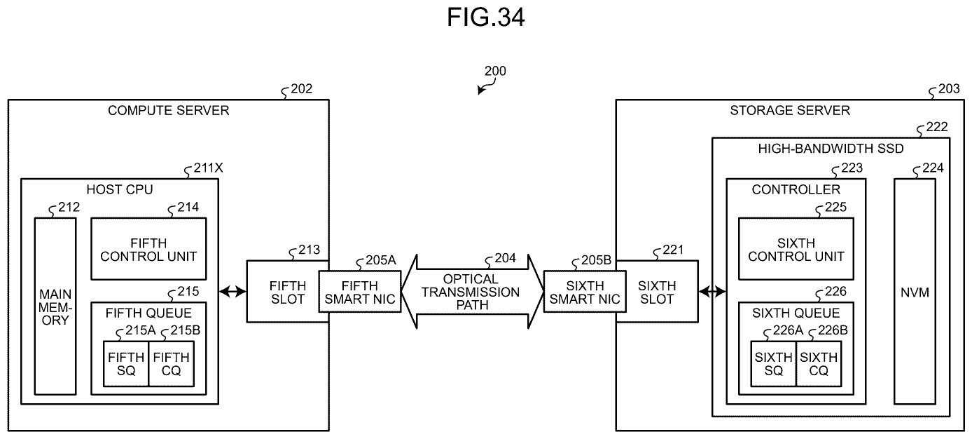

FIG. 34 is a diagram illustrated to describe an exemplary optical transmission system 200 according to the fifth embodiment. The optical transmission system 200 illustrated in FIG. 34 includes a compute server 202, a storage server 203, and an optical transmission path 204 that connects the compute server 202 and the storage server 203 for communication. The compute server 202 is a server that includes a host CPU 211X and a fifth slot 213. The host CPU 211X controls the overall operation of the compute server 202. The host CPU 211X includes a main memory 212, a fifth control unit 214 that controls the main memory 212, and a fifth queue 215 used for the NVMe-oF protocol. The main memory 212 is, for example, a DDR memory that stores data. The fifth queue 215 includes a fifth SQ 215A and a fifth CQ 215B. The fifth SQ 215A is, for example, a circular buffer on the compute server 202 side that queues NVMe-oF protocol processing requests issued by the host CPU 211X to a controller 223. The fifth CQ 215B is, for example, a circular buffer on the compute server 202 side that queues real ACKs indicating the completion of processing of the processing requests.

The optical transmission path 204 is, for example, an OTN optical transmission path that provides a communication connection between the compute server 202 and the storage server 203. The fifth slot 213 is, for example, a PCIe slot that connects to a fifth smart NIC 205A. The fifth smart NIC 205A is a NIC configured to enable communication using the NVMe-oF protocol over an optical transmission Layer 1 frame. The fifth smart NIC 205A is removably connectable to the fifth slot 213.

The storage server 203 is a counterpart device that includes a sixth slot 221 and a high-bandwidth SSD 222. The high-bandwidth SSD 222 controls the overall operation of the storage server 203. The high-bandwidth SSD 222 includes a controller 223 and an NVM 224. The controller 223 controls the overall operation of the high-bandwidth SSD 222. The controller 223 includes a sixth control unit 225 that controls the NVM 224 and a sixth queue 226 used for the NVMe-oF protocol. The sixth queue 226 includes a sixth SQ 226A and a sixth CQ 226B. The sixth SQ 226A is, for example, a circular buffer on the storage server 203 side that queues NVMe-oF protocol processing requests transferred from the host CPU 211X. The sixth CQ 226B is a circular buffer on the storage server 203 side that queues real ACKs indicating the completion of processing of a processing request. The NVM 224 is a non-volatile secondary storage device that stores data.

The sixth slot 221 is a PCIe slot that connects to a sixth smart NIC 205B. The sixth smart NIC 205B is a NIC configured to enable communication using the NVMe-oF protocol over an optical transmission Layer 1 frame. The sixth smart NIC 205B is removably connectable to the sixth slot 221.

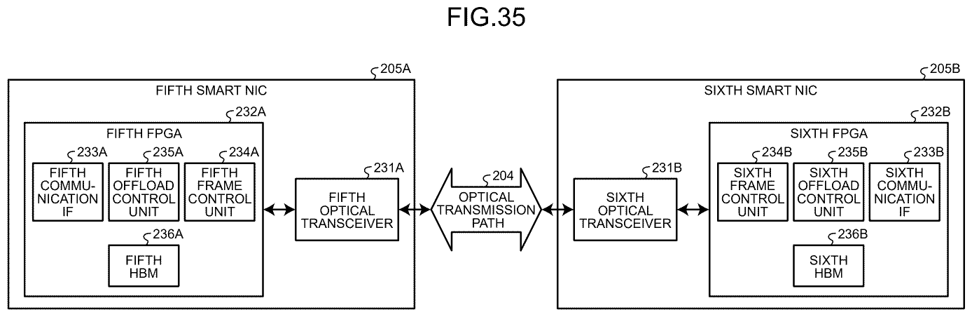

FIG. 35 is a diagram illustrated to describe an example of the fifth smart NIC 205A and the sixth smart NIC 205B used in the optical transmission system 200 according to the fifth embodiment. The fifth smart NIC 205A illustrated in FIG. 35 includes a fifth optical transceiver 231A and a fifth FPGA 232A. The fifth optical transceiver 231A is an optical transceiver equipped with optical-to-electrical conversion functionality for performing optical transmission with the optical transmission path 204. The fifth FPGA 232A includes a fifth communication IF 233A, a fifth frame control unit 234A, a fifth offload control unit 235A, and a fifth high-bandwidth memory (HBM) 236A. The fifth communication IF 233A is a communication IF for communication with the fifth slot 213. The fifth frame control unit 234A is a signal processing unit that encapsulates (assembles) or decapsulates (disassembles) a signal into or from an optical transmission Layer 1 frame during communication with the optical transmission path 204. The fifth offload control unit 235A reduces the processing load on the fifth control unit 214 by performing processing related to the NVMe-oF protocol. The fifth HBM 236A is a high-capacity memory device that stores data.

The sixth smart NIC 205B includes a sixth optical transceiver 231B and a sixth FPGA 232B. The sixth optical transceiver 231B is an optical transceiver equipped with optical-to-electrical conversion functionality for optical transmission with the optical transmission path 204. The sixth FPGA 232B includes a sixth communication IF 233B, a sixth frame control unit 234B, a sixth offload control unit 235B, and a sixth HBM 236B. The sixth communication IF 233B is a communication IF for communication with the sixth slot 221. The sixth frame control unit 234B is a signal processing unit that encapsulates or decapsulates a signal into or from the optical transmission Layer 1 frame during communication with the optical transmission path 204. The sixth offload control unit 235B reduces the processing load on the sixth control unit 225 by performing processing related to the NVMe-oF protocol. The sixth HBM 236B is a high-capacity memory device that stores data.

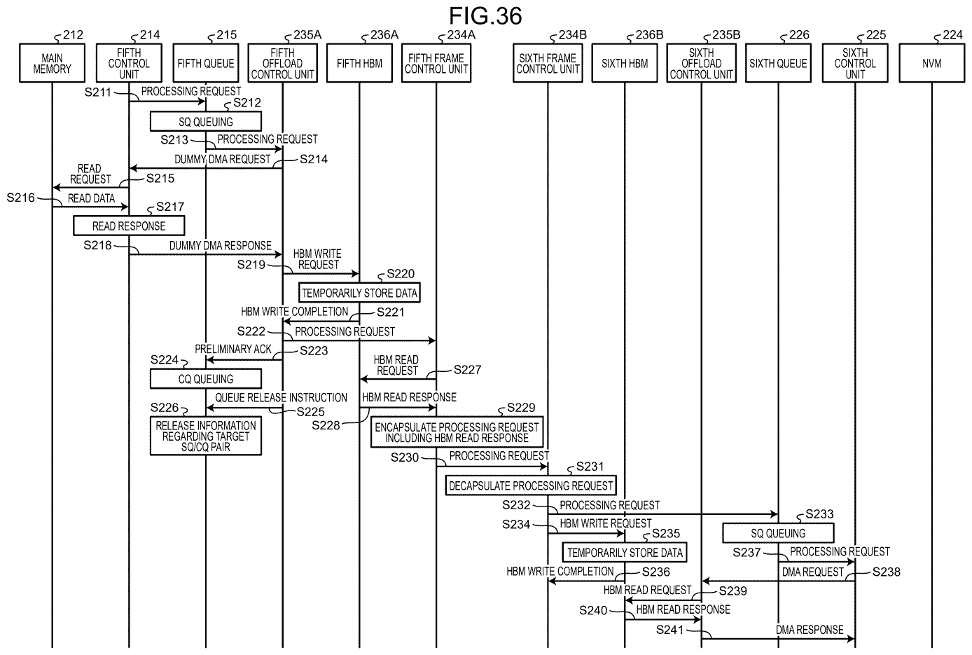

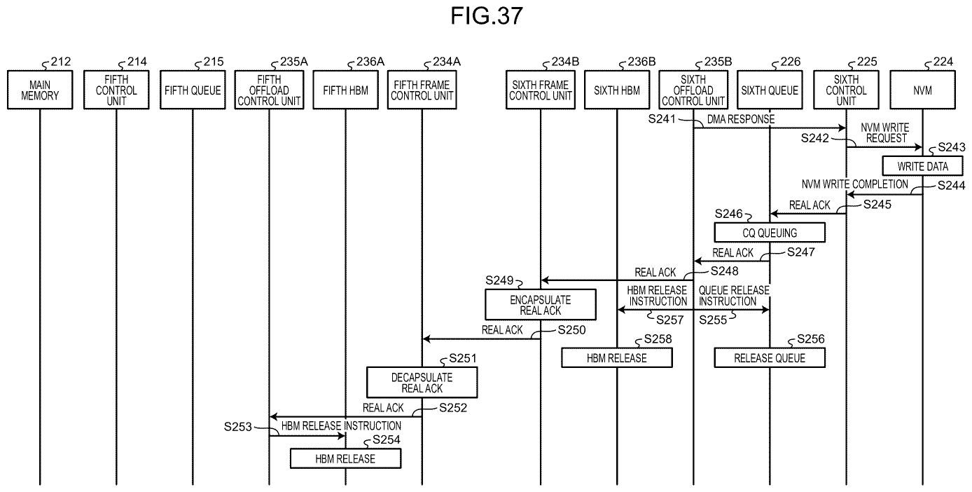

FIGS. 36 and 37 are sequence diagrams illustrating an example of the processing operation regarding the write-processing operation in the optical transmission system 200 according to the fifth embodiment. The fifth control unit 214 in the host CPU 211X issues a processing request of the NVMe-oF protocol, such as a processing request to write the write-target data that is stored in the main memory 212 into the NVM 224. Note that, for example, one processing request corresponds to one command. Then, the fifth control unit 214 notifies the fifth queue 215 of the issued processing request (step S211). The fifth SQ 215A in the fifth queue 215 performs SQ queuing of the notified processing request (step S212).

The fifth offload control unit 235A in the fifth smart NIC 205A detects a processing request queued in the fifth SQ 215A in accordance with the doorbell function of the fifth queue 215 (step S213). The fifth offload control unit 235A notifies the fifth control unit 214 of a dummy DMA request in response to the detected processing request (step S214). If the dummy DMA request is detected, the fifth control unit 214 issues, to the main memory 212, a read request to read the write-target data from the main memory 212 in response to the dummy DMA request (step S215). The main memory 212 reads the write-target data in response to the read request (step S216) and notifies the fifth control unit 214 of a read response including the write-target data that is read (step S217).

The fifth control unit 214, upon detecting the read response, notifies the fifth offload control unit 235A of a dummy DMA response including the write-target data that is read (step S218). The fifth offload control unit 235A, upon detecting the dummy DMA response, sends, to the fifth HBM 236A, an HBM write request including the write-target data in the dummy DMA response (step S219). The fifth HBM 236A temporarily stores the write-target data included in the HBM write request in response to the HBM write request (step S220) and notifies the fifth offload control unit 235A of the completion of the HBM write (step S221). In other words, the fifth offload control unit 235A reads the write-target data from the main memory 212 in response to the processing request and temporarily stores the write-target data that is read in the fifth HBM 236A.

Further, after detecting the completion of the HBM write, the fifth offload control unit 235A notifies the fifth frame control unit 234A of the processing request detected in step S213 (step S222). In the case where the processing request is detected, the fifth frame control unit 234A issues, to the fifth HBM 236A, an HBM read request to read the write-target data that is stored in the fifth HBM 236A (step S227). The fifth HBM 236A, in response to the HBM read request, notifies the fifth frame control unit 234A of an HBM read response including the write-target data that is read (step S228). The fifth frame control unit 234A encapsulates the processing request including the HBM read response (step S229). The fifth frame control unit 234A optically converts the encapsulated processing request via the fifth optical transceiver 231A and optically transmits the optically converted processing request to the sixth smart NIC 205B through the optical transmission path 204 (step S230). In other words, the fifth offload control unit 235A reads the write-target data that is temporarily stored in the fifth HBM 236A and optically transmits the processing request including the write-target data, which is read, to the sixth smart NIC 205B as the first handshake.

Further, after notifying the fifth frame control unit 234A of the processing request in step S222, the fifth offload control unit 235A notifies the fifth queue 215 of a preliminary ACK (step S223). The fifth CQ 215B in the fifth queue 215 performs CQ queuing of the notified preliminary ACK (step S224). Then, the fifth offload control unit 235A notifies the fifth queue 215 of a queue release instruction (step S225). The fifth queue 215, in response to the queue release instruction, releases the information regarding the target SQ/CQ pair (step S226). In other words, the fifth offload control unit 235A releases the queue in the fifth queue 215 before the processing request including the write-target data is executed by the sixth smart NIC 205B.

The sixth frame control unit 234B in the sixth smart NIC 205B electrically converts the encapsulated processing request via the sixth optical transceiver 231B and decapsulates the electrically converted processing request to separate the encapsulated and converted processing request into the processing request and the write-target data (step S231). The sixth frame control unit 234B notifies the sixth queue 226 in the controller 223 of the separated processing request (step S232). The sixth SQ 226A in the sixth queue 226 performs SQ queuing of the processing request (step S233). In addition, the sixth frame control unit 234B issues, to the sixth HBM 236B, an HBM write request to write the separated write-target data into the sixth HBM 236B (step S234).

The sixth HBM 236B temporarily stores the write-target data contained in the HBM write request in response to the HBM write request (step S235) and notifies the sixth offload control unit 235B of the completion of the HBM write (step S236).

The sixth control unit 225, in accordance with the doorbell function of the sixth queue 226, detects the processing request queued in the sixth SQ 226A (step S237). The sixth control unit 225 notifies the sixth offload control unit 235B of a DMA request in response to the detected processing request (step S238). The sixth offload control unit 235B issues an HBM read request to the sixth HBM 236B to read the write-target data from the sixth HBM 236B in response to the DMA request (step S239). The sixth HBM 236B reads the write-target data in response to the HBM read request and notifies the sixth offload control unit 235B of an HBM read response including the write-target data that is read (step S240). The sixth offload control unit 235B, upon detecting the HBM read response, notifies the sixth control unit 225 of a DMA response including the write-target data that is read, as illustrated in FIG. 37 (step S241). Thus, the sixth control unit 225 is capable of acquiring the write-target data from the sixth HBM 236B in response to the DMA request.

The sixth control unit 225 issues to the NVM 224 an NVM write request to write the write-target data contained in the DMA response into the NVM 224 (step S242). The NVM 224 writes the write-target data in response to the NVM write request (step S243), and after the write is complete, notifies the sixth control unit 225 of the completion of the NVM write (step S244). Upon detecting the completion of the NVM write, the sixth control unit 225 notifies the sixth queue 226 of a real ACK (step S245). The sixth CQ 226B in the sixth queue 226 performs CQ queuing in response to the real ACK (step S246).

The sixth offload control unit 235B detects the real ACK in the sixth CQ 226B in accordance with the doorbell function of the sixth queue 226 (step S247). The sixth offload control unit 235B notifies the sixth frame control unit 234B of the detected real ACK (step S248). Upon detecting the real ACK from the sixth offload control unit 235B, the sixth frame control unit 234B encapsulates the real ACK (step S249). The sixth frame control unit 234B optically converts the encapsulated processing completion flag via the sixth optical transceiver 231B and optically transmits the optically converted processing completion flag to the fifth smart NIC 205A through the optical transmission path 204 (step S250). Moreover, the real ACK in step S250 corresponds to the second handshake. However, since the information regarding the SQ/CQ pair targeted by the fifth queue 215 has already been released in step S226, this processing does not affect the throughput on the side of the host CPU 211X.

The fifth frame control unit 234A in the fifth smart NIC 205A electrically converts the encapsulated real ACK via the fifth optical transceiver 231A and decapsulates the electrically converted real ACK (step S251). Furthermore, the fifth frame control unit 234A notifies the fifth offload control unit 235A of the decapsulated real ACK (step S252). The fifth offload control unit 235A issues an HBM release instruction to the fifth HBM 236A in response to the real ACK (step S253). Then, the fifth HBM 236A executes HBM release to erase the write-target data in response to the HBM release instruction (step S254), thereby completing the processing operation illustrated in FIG. 37. As a result, the fifth HBM 236A is capable of erasing the write-target data in response to the HBM release instruction.

Further, after notifying the sixth frame control unit 234B of the real ACK in step S248, the sixth offload control unit 235B notifies the sixth queue 226 of a queue release instruction (step S255). Then, the sixth queue 226 releases the information regarding the target SQ/CQ pair (step S256).

Further, after notifying the sixth frame control unit 234B of the real ACK in step S248, the sixth offload control unit 235B notifies the sixth HBM 236B of an HBM release instruction (step S257). The sixth HBM 236B executes HBM release to erase the write-target data in response to the HBM release instruction (step S258), thereby completing the processing operation illustrated in FIG. 37. As a result, the sixth HBM 236B is capable of erasing the write-target data in response to the HBM release instruction.

In the case where the fifth smart NIC 205A detects the issuance of a processing request from the fifth control unit 214, the fifth smart NIC 205A reads the write-target data corresponding to the processing request from the main memory 212 and stores the write-target data in the fifth HBM 236A. The fifth smart NIC 205A optically transmits the processing request, including the write-target data stored in the fifth HBM 236A, to the storage server 203 as the first handshake. The fifth smart NIC 205A, before executing the processing request on the storage server 203 side, performs CQ queuing of a preliminary ACK corresponding to the processing request in the fifth CQ 215B and releases the queue.

Upon detecting the processing request from the fifth smart NIC 205A, the sixth smart NIC 205B performs SQ queuing of the processing request in the sixth SQ 226A and stores the write-target data in the sixth HBM 236B. The sixth control unit 225 stores the write data stored in the sixth HBM 236B in the NVM 224 in response to the processing request in the sixth SQ 226A. Then, in the case where the writing of the data to the NVM 224 is completed, the sixth control unit 225 performs CQ queuing of a real ACK for the processing request in the sixth CQ 226B and releases the real ACK. Furthermore, the sixth smart NIC 205B optically transmits the real ACK as the second handshake to the compute server 202. Then, the fifth smart NIC 205A releases the fifth HBM 236A in response to the real ACK.

In other words, in the optical transmission system 200, a single handshake for the processing request in step S230 suffices between the compute server 202 and the storage server 203 from SQ queuing to the release of the information regarding the SQ/CQ pair. This makes it possible to shorten the transmission latency related to each processing request. In other words, it is possible to implement an NVMe-oF optical transmission system 200 suitable for long-distance transmission, which improves processing latency including transmission latency without increasing the number of CPU cores.

Upon detecting the issuance of a processing request from the compute server 202 to the storage server 203, the fifth smart NIC 205A performs SQ queuing of the processing request in the fifth queue 215. The fifth smart NIC 205A retrieves data corresponding to the processing request from the main memory 212 and stores the retrieved data in the fifth HBM 236A. After requesting the transfer of the data and the processing request to the storage server 203, the fifth smart NIC 205A performs CQ queuing of the preliminary ACK for the processing request in the fifth queue 215 and releases the queued preliminary ACK. Thus, the reduction in the number of handshakes involved in the processing requests between the compute server 202 and the storage server 203 allows transmission latency to be suppressed and throughput to be improved.

Upon receiving the processing request and data transferred from the fifth smart NIC 205A, the sixth smart NIC 205B stores the received data in the sixth HBM 236B. The sixth smart NIC 205B performs SQ queuing of the received processing request in the sixth queue 226, and executes a write-processing operation of the data stored in the sixth HBM 236B to the NVM 224 in response to the processing request queued in the sixth queue 226. After executing the write-processing operation, the sixth smart NIC 205B performs CQ queuing of the real ACK for the processing request in the sixth queue 226 and releases the queued real ACK. Thus, the reduction in the number of handshakes involved in the processing requests between the compute server 202 and the storage server 203 allows transmission latency to be suppressed and throughput to be improved.

In the optical transmission system 200 according to the fifth embodiment, a single processing request in step S230 suffices the handshake between the fifth smart NIC 205A and the sixth smart NIC 205B from SQ queuing to the release of the information regarding the SQ/CQ pair. Thus, compared to the first comparative example, it is possible to reduce the number of handshake processes by four. As a result, it is possible for the optical transmission system 200 to suppress transmission latency by reducing the number of handshakes related to DMA requests, DMA responses, and queue release instructions, as in the first comparative example, thereby significantly shortening the processing latency related to the processing request.

In the case where the fifth smart NIC 205A detects the issuance of a processing request from the host CPU 211X to the high-bandwidth SSD 222 and the command contains one processing request, the fifth smart NIC 205A queues the processing request in the fifth SQ 215A and retrieves data corresponding to the processing request from the main memory 212. After requesting the transfer of data and processing requests to the high-bandwidth SSD 222, the fifth smart NIC 205A queues the completion of processing of the processing request in the fifth CQ 215B and releases the queue for completion of processing before executing the processing request on the high-bandwidth SSD 222. As a result, it is possible to significantly reduce the processing latency related to the processing request.

The sixth smart NIC 205B includes the sixth HBM 236B and the sixth offload control unit 235B, which controls the sixth SQ 226A and the sixth CQ 226B and also controls the sixth HBM 236B. Upon receiving the processing request and data transferred from the compute server 202, the sixth offload control unit 235B stores the received data in the sixth HBM 236B.

The sixth offload control unit 235B performs queuing of the received processing request in the sixth SQ 226A and executes the processing request using data stored in the sixth HBM 236B in response to the processing requests queued in the sixth SQ 226A. Then, the sixth offload control unit 235B, after executing the processing request, performs queuing of the completion of the processing request in the sixth CQ 226B and releases the queue for the completion of processing. Thus, the reduction in the number of handshakes involved in the processing requests between the compute server 202 and the storage server 203 allows transmission latency to be suppressed and throughput to be improved.

Upon detecting an error in the data related to the processing request, the sixth offload control unit 235B issues a reprocessing request and queues the reprocessing request in the sixth SQ 226A. The sixth offload control unit 235B reads the corresponding data from the sixth HBM 236B in response to the reprocessing request queued in the sixth SQ 226A. Furthermore, the sixth offload control unit 235B executes the processing request using the read data and, after completing the processing, queues the completion of processing of the processing request in the sixth CQ 226B and releases the queue of the completion of processing.

Upon detecting a processing completion flag indicating an error history, the sixth control unit 225 re-reads the write-target data that is stored in the sixth HBM 236B and writes the read data to the NVM 224. This processing makes it possible to re-acquire write-target data lost due to an error and to write the re-acquired data to the NVM 224.

Upon detecting an error in the data related to the processing request, the sixth offload control unit 235B issues a reprocessing request and queues the reprocessing request in the sixth SQ 226A. The sixth offload control unit 235B receives the corresponding data stored in the fifth smart NIC 205A and executes the processing request using the received data in response to the reprocessing request queued in the sixth SQ 226A. Furthermore, after completing the processing request, the sixth offload control unit 235B queues the completion of processing of the processing request in the sixth CQ 226B and releases the queue of the completion of processing.

Upon detecting a processing completion flag indicating an error history, the sixth control unit 225 re-acquires the write-target data that is stored in the fifth HBM 236A and writes the acquired write-target data to the NVM 224. This processing makes it possible to re-acquire write-target data lost due to an error and to write the re-acquired data to the NVM 224.

However, with the recent spread of technologies such as artificial intelligence (AI) and large language model (LLM), distributed computing using multiple processors is now commonly employed for performing large-scale data processing in data centers.

Thus, in the case of involving large-scale data processing, limitations may arise in node-local resources, and storage, which is more flexible in terms of response time, is more likely to utilize remote resources. In addition, use of remote storage as virtual memory for compute clusters is also anticipated. Thus, in the case where storage is located at a remote site, the optical transmission system 200 according to the fifth embodiment is applicable. Thus, an optical transmission system according to a sixth embodiment, which employs distributed computing processing, is now described. Note that components identical to those in the optical transmission system 200 according to the fifth embodiment are denoted with the same reference numerals, and repeated descriptions of those components and operations are omitted.

### (c) Sixth Embodiment

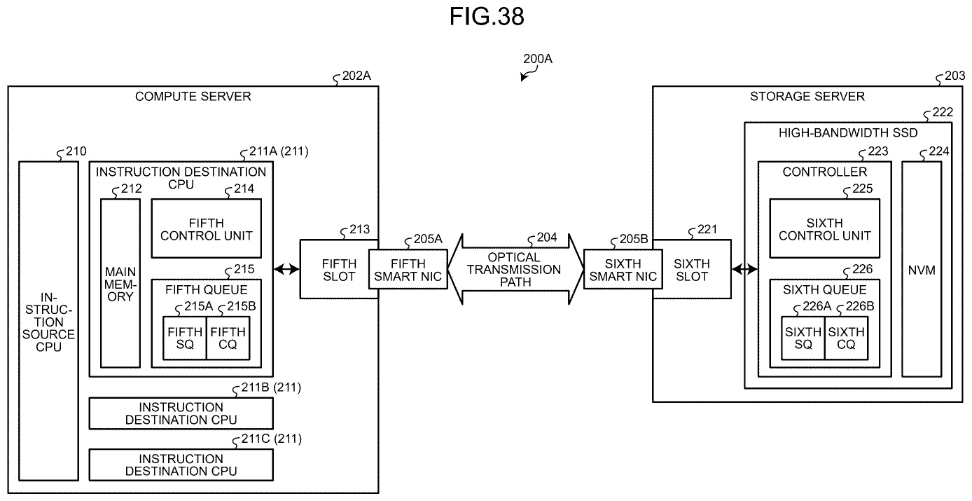

FIG. 38 is a diagram illustrated to describe an exemplary optical transmission system 200A according to the sixth embodiment. The optical transmission system 200A according to the sixth embodiment includes a compute server 202A, a storage server 203, an optical transmission path 204, a fifth smart NIC 205A, and a sixth smart NIC 205B. The compute server 202A includes an instruction source CPU 210, a plurality of instruction destination CPUs 211 that receive instructions distributed by the instruction source CPU 210, and a fifth slot 213.

The instruction source CPU 210 controls the plurality of instruction destination CPUs 211. Moreover, for convenience of description, the multiple instruction destination CPUs 211 are assumed to be, for example, three instruction destination CPUs, that is, an instruction destination CPU 211A, an instruction destination CPU 211B, and an instruction destination CPU 211C. Each of the instruction destination CPUs 211 includes a fifth control unit 214, a fifth queue 215, and a main memory 212.

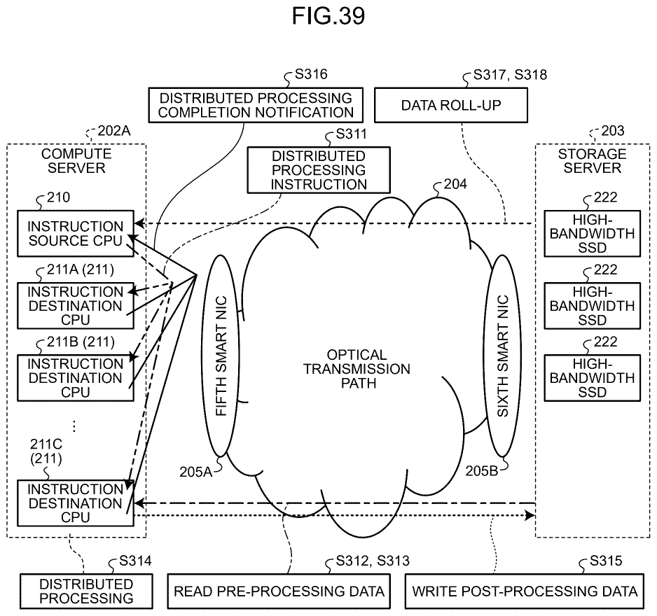

FIG. 39 is a diagram illustrated to describe an example of the processing operation related to parallel distributed processing in the optical transmission system 200A according to the sixth embodiment. The parallel distributed processing refers to distributed processing in which each of the instruction destination CPUs 211 executes processing in parallel in response to an instruction from the instruction source CPU 210.

The instruction source CPU 210 issues a distributed processing instruction to each of the instruction destination CPUs 211 (step S311). In response to the distributed processing instruction, each of the instruction destination CPUs 211 issues a read request to the high-bandwidth SSD 222 to read the pre-distributed processing data from the high-bandwidth SSD 222 in the storage server 203 (step S312). Then, the high-bandwidth SSD 222 reads the pre-distributed processing data in response to the read request from each of the instruction destination CPUs 211 and transmits the read pre-distributed processing data to the respective instruction destination CPUs 211 (step S313).

The respective instruction destination CPUs 211 perform distributed processing on the read pre-distributed processing data (step S314). Each of the instruction destination CPUs 211 performs write-processing operation to write the post-distributed processing data to the high-bandwidth SSD 222 (step S315). Upon completion of the write-processing operation, each of the instruction destination CPUs 211 transmits a distributed processing completion notification to the instruction source CPU 210 (step S316).

In the case where the instruction source CPU 210 receives the distributed processing completion notification from all of the instruction destination CPUs 211, the instruction source CPU 210 recognizes that the post-distributed processing data from all of the instruction destination CPUs 211 has been written to the high-bandwidth SSD 222 and all the distributed processing has been completed.

Then, the instruction source CPU 210 issues a data roll-up request to the high-bandwidth SSD 222 to read the post-distributed processing data written to the high-bandwidth SSD 222 (step S317). Moreover, the data roll-up request is transmitted to the high-bandwidth SDD 222 via a separate route from the instruction source CPU 210, without passing through the instruction destination CPU 211. In response to the data roll-up request, the high-bandwidth SSD 22 reads the post-distributed processing data and transmits the read distributed processing data to the instruction source CPU 210 as the data roll-up result (step S318). Moreover, the data roll-up result is also transmitted from the high-bandwidth SSD 222 to the instruction source CPU 210 via a separate route, without passing through the instruction destination CPU 211.

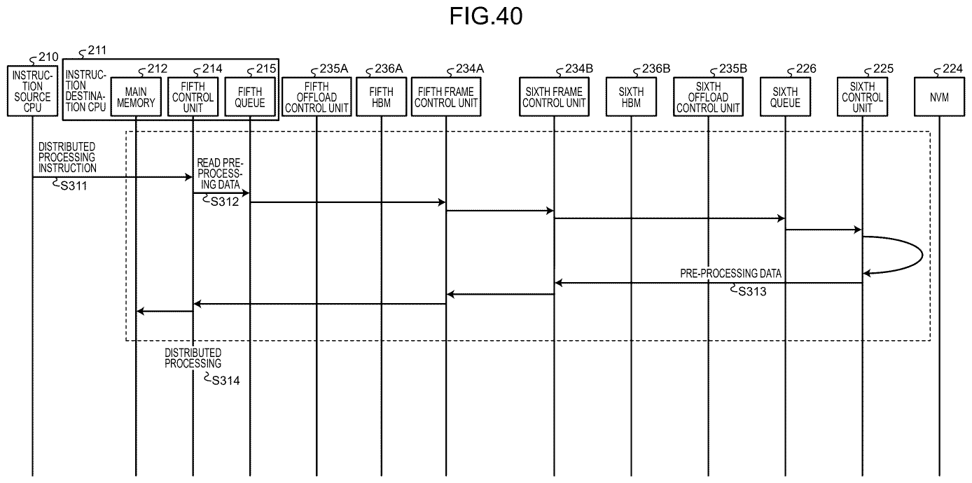

FIG. 40 is a sequence diagram illustrating an example of the processing operation related to the pre-processing in the optical transmission system 200A according to the sixth embodiment. In FIG. 40, the instruction source CPU 210 issues a distributed processing instruction to each of the instruction destination CPUs 211 (step S311). In response to the distributed processing instruction, each of the instruction destination CPUs 211 issues a read request to the high-bandwidth SSD 222 to read the pre-distributed processing data from the high-bandwidth SSD 222 in the storage server 203 (step S312). The fifth control unit 214 in the instruction destination CPU 211 uses the fifth queue 215 to transmit the read request to the fifth frame control unit 234A in the fifth smart NIC 205A. The fifth frame control unit 234A in the fifth smart NIC 205A transmits the read request to the sixth frame control unit 234B in the sixth smart NIC 205B through the optical transmission path 204. Then, the sixth frame control unit 234B in the sixth smart NIC 205B transmits the read request to the sixth queue 226 in the high-bandwidth SSD 222.

Then, in response to a read request from each of the instruction destination CPUs 211, the high-bandwidth SSD 222 reads the pre-distributed processing data from the NVM 224 and transmits the read pre-distributed processing data to each of the instruction destination CPUs 211 (step S313). Specifically, the sixth control unit 225 in the high-bandwidth SSD 222 reads the pre-distributed processing data from the NVM 224 in response to the read request from the sixth queue 226. The sixth control unit 225 transmits the pre-distributed processing data read from the NVM 224 to the sixth frame control unit 234B in the sixth smart NIC 205B. The sixth frame control unit 234B in the sixth smart NIC 205B transmits the pre-distributed processing data to the fifth frame control unit 234A in the fifth smart NIC 205A through the optical transmission path 204. Then, the fifth frame control unit 234A in the fifth smart NIC 205A transmits the pre-distributed processing data to the fifth control unit 214 in the instruction destination CPU 211. The fifth control unit 214 stores the received pre-distributed processing data from the fifth frame control unit 234A in the main memory 212.

The respective instruction destination CPUs 211 perform distributed processing on the read pre-distributed processing data (step S314). Each of the instruction destination CPUs 211 performs write-processing operation to write the post-distributed processing data to the high-bandwidth SSD 222 (step S315). Moreover, for convenience of description, one write-processing operation is assumed to involve dividing the post-distributed processing data into three segments and executing the write-processing operation to the NVM 224 in three separate processing requests. In other words, each of the instruction destination CPUs 211 is assumed to construct one instance of write-processing operation command using three processing requests, and to implement one write-processing operation through the execution of these three processing requests.

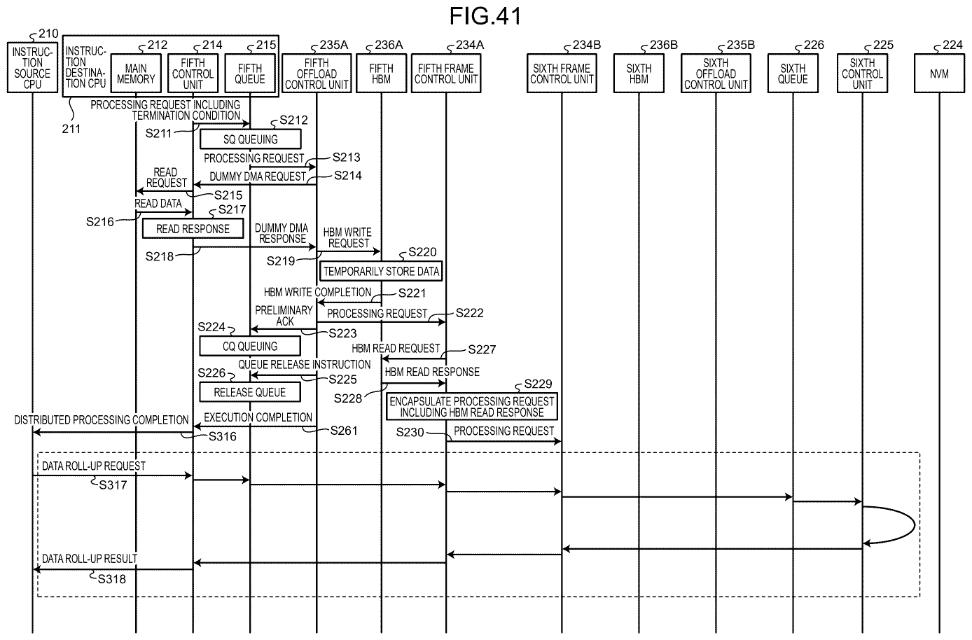

FIG. 41 is a sequence diagram illustrating an example of the processing operation related to the write-processing operation and data roll-up processing in the optical transmission system 200A according to the sixth embodiment. In FIG. 41, the fifth control unit 214 notifies the fifth queue 215 of a processing request in step S211. Then, the optical transmission system 200A executes the processing of steps S212, S213, S214, S215, S216, S217, S218, S219, S220, and S221.

Then, upon detecting completion of the HBM write in step S221, the fifth offload control unit 235A notifies the fifth frame control unit 234A of a processing request in step S222. Subsequently, the optical transmission system 200A sequentially executes the processing of steps S227, S228, S229, S230, S231, S232, S233, S237, S238, S239, S240, and S241. From step S241 onwards, the subsequent processing illustrated in FIG. 41 is executed sequentially. Moreover, it is assumed that one write-processing operation is implemented with three processing requests.

Further, the fifth offload control unit 235A notifies the fifth frame control unit 234A of the first processing request in step S222, and then notifies the fifth queue 215 of a preliminary ACK in step S223. The fifth CQ 215B in the fifth queue 215 performs CQ queuing of the preliminary ACK in step S224. The fifth queue 215 releases the information regarding the target SQ/CQ pair in step S226. In other words, the fifth offload control unit 235A releases the queue in the fifth queue 215 before the processing request including the write-target data is executed by the sixth smart NIC 205B.

Further, after notifying the fifth queue 215 of the preliminary ACK in step S223, the fifth offload control unit 235A notifies the fifth control unit 214 of the completion of execution, indicating the completion of the write-processing operation (step S261).

Upon detecting the completion of execution from the fifth offload control unit 235A, the fifth control unit 214 in each of the instruction destination CPUs 211 transmits a distributed processing completion notification to the instruction source CPU 210 (step S316).

Upon receiving the distributed processing completion notifications from all of the instruction destination CPUs 211, the instruction source CPU 210 determines that the post-distributed processing data from all of the instruction destination CPUs 211 has been written to the high-bandwidth SSD 222 and all the distributed processing has been completed.

Then, the instruction source CPU 210 instructs each of the instruction destination CPUs 211 to issue a data roll-up request for reading the post-write processing data written to the high-bandwidth SSD 222 (step S317). The high-bandwidth SSD 222, in response to the data roll-up request, reads the post-write processing data and transmits the read post-write processing data to the instruction source CPU 210 as the data roll-up result (step S318).

In the optical transmission system 200 according to the sixth embodiment, it is possible to suppress throughput degradation by accelerating the release of queuing in the fifth queue 215 using the preliminary ACK issued by the first smart NIC 205A, as a local rule applied only between the NVMe-oF endpoints. However, the timing of writing actual data to the NVM 224 still depends on the specifications of the NVMe-SSD, just as in conventional systems, and until that write is complete, the data mainly resides in the fifth HBM 236A of the fifth smart NIC 205A.

In other words, although the data has not actually been written to the NVM 224 in the high-bandwidth SSD 222, the fifth offload control unit 235A notifies the fifth control unit 214 in the instruction destination CPU 211 of the completion of execution. Then, the fifth control unit 214 notifies the instruction source CPU 210 of a distributed processing completion notification in response to the completion of execution. As a result, even though the instruction source CPU 210 has received the distributed processing completion notification from all of the instruction destination CPUs 211, it is unable to read the post-write processing data from the NVM 224 during data roll-up and fails to ensure the access order. Thus, an embodiment suitable for addressing this situation is described below as a first embodiment according to the present disclosure.

### (d) First Embodiment

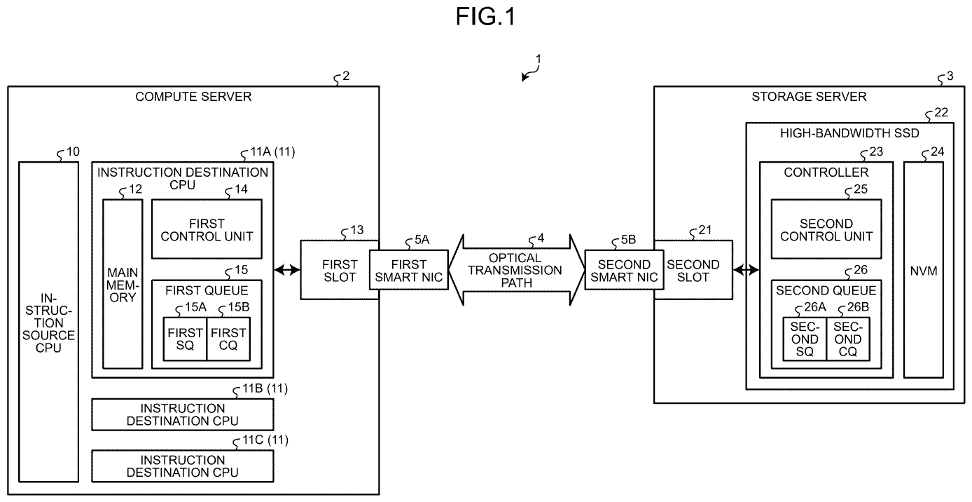

FIG. 1 is a diagram illustrated to describe an exemplary optical transmission system 1 according to a first embodiment. The optical transmission system 1 illustrated in FIG. 1 includes a compute server 2, a storage server 3, and an optical transmission path 4 that connects the compute server 2 and the storage server 3 for communication. The compute server 2 is a first device, such as a server, including an instruction source central processing unit (CPU) 10, a plurality of instruction destination CPUs 11 that are the distributed processing destinations of the instruction source CPU 10, and a first slot 13. The instruction source CPU 10 controls the overall operation of the compute server 2 and also controls the instruction destination CPUs 11. Moreover, for convenience of description, the multiple instruction destination CPUs 11 are assumed to be, for example, three instruction destination CPUs, that is, an instruction destination CPU 11A, an instruction destination CPU 11B, and an instruction destination CPU 11C.

Each of the instruction destination CPUs 11 is a control device including a first control unit 14, a first queue 15 used for the NVMe-oF protocol, and a main memory 12, with the first control unit 14 being configured to control the main memory 12. The first queue 15 includes a first submission queue (SQ) 15A and a first completion queue (CQ) 15B. The first SQ 15A is, for example, a circular buffer on the compute server 2 side that queues NVMe-oF protocol processing requests issued by the instruction destination CPU 11 to a controller 23. In addition, the first CQ 15B is a circular buffer on the compute server 2 side that queues processing completion flags indicating the completion of processing of a processing request.

The main memory 12 is, for example, a double data rate (DDR) memory that stores data. The optical transmission path 4 is, for example, an optical transmission line based on wavelength division multiplexing (WDM) of an optical transport network (OTN) that connects the compute server 2 and the storage server 3 for communication. The first slot 13 is, for example, a peripheral component interconnect express (PCIe) slot that connects to a first smart network interface card (NIC) 5A. The first smart NIC 5A is a transmission device such as a NIC configured to enable communication using the NVMe-oF protocol over an optical transmission Layer 1 frame. The first smart NIC 5A is removably connectable to the first slot 13.

The storage server 3 is a second device including a second slot 21 and a high-bandwidth solid state drive (SSD) 22. The high-bandwidth SSD 22 is a processing device that controls the overall operation of the storage server 3. The high-bandwidth SSD 22 includes a controller 23 and a non-volatile memory (NVM) 24. The controller 23 controls the overall operation of the high-bandwidth SSD 22. The controller 23 includes a second control unit 25 that controls the NVM 24 and a second queue 26 used for the NVMe-oF protocol. The second queue 26 includes a second SQ 26A and a second CQ 26B. The second SQ 26A is, for example, a circular buffer on the storage server 3 side that queues NVMe-oF protocol processing requests transferred from the instruction destination CPU 11. The second CQ 26B is a circular buffer on the storage server 3 side that queues processing completion flags indicating the completion of processing of processing requests. The NVM 24 is a non-volatile secondary storage device that stores data.

The second slot 21 is a PCIe slot that connects to a second smart NIC 5B. The second smart NIC 5B is a NIC configured to enable communication using the NVMe-oF protocol over an optical transmission Layer 1 frame. The second smart NIC 5B is removably connectable to the second slot 21.

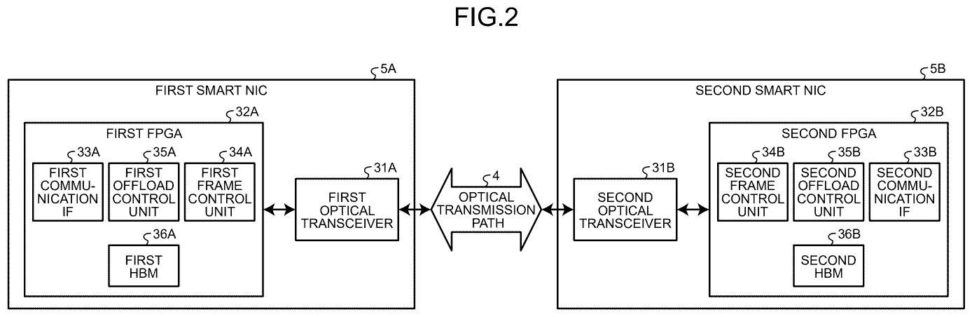

FIG. 2 is a diagram illustrated to describe an example of the first smart NIC 5A and the second smart NIC 5B used in the optical transmission system 1 according to the first embodiment. The first smart NIC 5A illustrated in FIG. 2 includes a first optical transceiver 31A and a first field-programmable gate array (FPGA) 32A. The first optical transceiver 31A is an optical transceiver equipped with optical-to-electrical conversion functionality for optical transmission with the optical transmission path 4. The first FPGA 32A includes a first communication IF 33A, a first frame control unit 34A, a first offload control unit 35A, and a first high-bandwidth memory (HBM) 36A. The first communication IF 33A is a communication IF for communication with the first slot 13. The first frame control unit 34A is a signal processing unit that encapsulates (assembles) or decapsulates (disassembles) a signal into or from the optical transmission Layer 1 frame for communication with the optical transmission path 4. The first offload control unit 35A reduces the processing load on the first control unit 14 by executing processing related to the NVMe-oF protocol. The first HBM 36A is a high-capacity memory device that stores data.

The second smart NIC 5B includes a second optical transceiver 31B and a second FPGA 32B. The second optical transceiver 31B is an optical transceiver equipped with optical-to-electrical conversion functionality for performing optical transmission with the optical transmission path 4. The second FPGA 32B includes a second communication IF 33B, a second frame control unit 34B, a second offload control unit 35B, and a second HBM 36B. The second communication IF 33B is a communication IF for communication with the second slot 21. The second frame control unit 34B is a signal processing unit that encapsulates or decapsulates a signal into or from the optical transmission Layer 1 frame for communication with the optical transmission path 4. The second offload control unit 35B reduces the processing load on the second control unit 25 by executing processing related to the NVMe-oF protocol. The second HBM 36B is a high-capacity memory device for storing data.

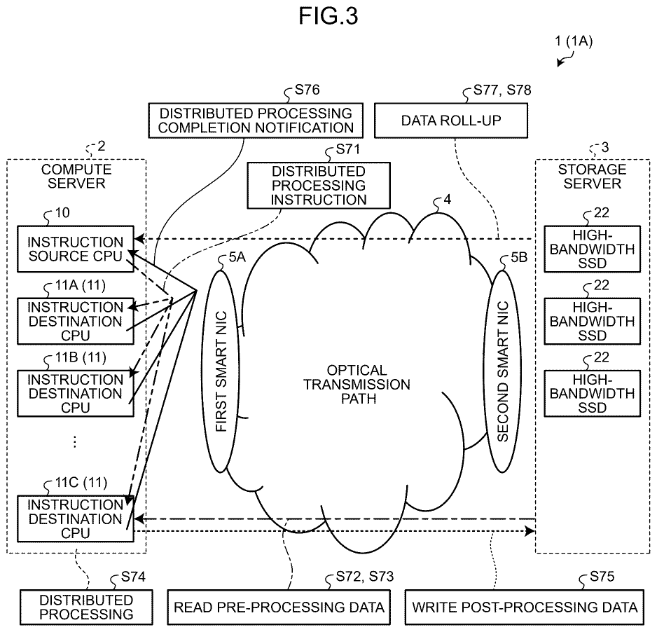

FIG. 3 is a diagram illustrated to describe an example of the processing operation related to parallel distributed processing in the optical transmission system 1 according to the first embodiment. The parallel distributed processing is a processing operation in which each of the instruction destination CPUs 11 executes processing in parallel in response to a distributed processing instruction from the instruction source CPU 10.

The instruction source CPU 10 issues a distributed processing instruction to each of the instruction destination CPUs 11 (step S71). In response to the distributed processing instruction, each of the instruction destination CPUs 11 issues a read request to the high-bandwidth SSD 22 to read the pre-distributed processing data from the high-bandwidth SSD 222 in the storage server 3 (step S72). Then, the high-bandwidth SSD 22 reads the pre-distributed processing data in response to the read request from each of the instruction destination CPUs 11 and transmits the read pre-distributed processing data to each of the instruction destination CPUs 11 (step S73).

Each of the instruction destination CPUs 11 executes distributed processing on the read pre-distributed processing data (step S74). Each of the instruction destination CPUs 11 performs a write-processing operation to write the post-distributed processing data to the high-bandwidth SSD 22 (step S75). Upon completion of the write-processing operation, each of the instruction destination CPUs 11 transmits a distributed processing completion notification to the instruction source CPU 10 (step S76).

The distributed processing completion notification can be transmitted using, for example, an interrupt command, such as an IRQ PIN, MSI, or SNMP trap.

Upon receiving the distributed processing completion notification from all of the instruction destination CPUs 11, the instruction source CPU 10 determines that the post-write processing data from all of the instruction destination CPUs 11 has been written to the high-bandwidth SSD 22 and that the distributed processing by all of the instruction destination CPUs 11 has been completed.

Subsequently, the instruction source CPU 10 issues a data roll-up request to the high-bandwidth SSD 22 to read the post-write processing data written to the high-bandwidth SSD 22 (step S77). The high-bandwidth SSD 22 reads the post-write processing data in response to the data roll-up request and transmits the read post-write processing data to the instruction source CPU 10 as the data roll-up result (step S78).

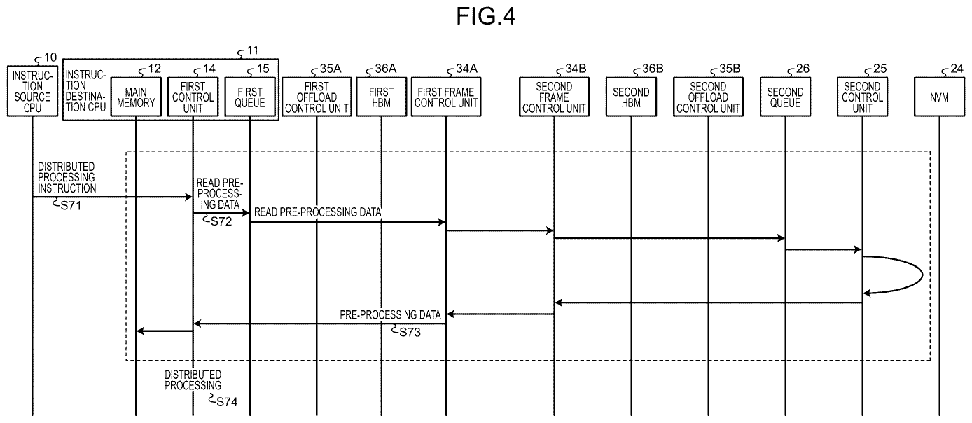

FIG. 4 is a sequence diagram illustrating an example of the processing operation related to pre-processing in the optical transmission system 1 according to the first embodiment. The pre-processing is a processing operation in which pre-distributed processing data is read from the NVM 24 and written to the main memory 12 in response to the distributed processing instruction. In FIG. 4, the instruction source CPU 10 issues a distributed processing instruction to each of the instruction destination CPUs 11 (step S71). In response to the distributed processing instruction, each of the instruction destination CPUs 11 issues a read request to the high-bandwidth SSD 22 to read the pre-distributed processing data from the high-bandwidth SSD 222 in the storage server 3 (step S72). The first control unit 14 in the instruction destination CPU 11 transmits the read request to the first frame control unit 34A in the first smart NIC 5A using the first queue 15. The first frame control unit 34A in the first smart NIC 5A transmits the read request to the second frame control unit 34B in the second smart NIC 5B through the optical transmission path 4. Then, the second frame control unit 34B in the second smart NIC 5B transmits the read request to the second queue 26 in the high-bandwidth SSD 22.

Subsequently, the high-bandwidth SSD 22 reads the pre-distributed processing data in response to the read request from each of the instruction destination CPUs 11 and transmits the read pre-distributed processing data to each of the instruction destination CPUs 11 (step S73). Specifically, the second control unit 25 in the high-bandwidth SSD 22 reads the pre-distributed processing data from the NVM 24 in response to the read request from the second queue 26. The second control unit 25 transmits the pre-distributed processing data read from the NVM 24 to the second frame control unit 34B in the second smart NIC 5B. The second frame control unit 34B in the second smart NIC 5B transmits the pre-distributed processing data to the first frame control unit 34A in the first smart NIC 5A through the optical transmission path 4. The first frame control unit 34A in the first smart NIC 5A transmits the pre-distributed processing data to the first control unit 14 in the instruction destination CPU 11. The first control unit 14 stores the pre-distributed processing data from the first frame control unit 34A in the main memory 12.

Each of the instruction destination CPUs 11 executes distributed processing on the read pre-distributed processing data (step S74). Each of the instruction destination CPUs 11 performs a write-processing operation to write the post-distributed processing data to the high-bandwidth SSD 22 (step S75). Moreover, for convenience of description, one write-processing operation is assumed to be performed by dividing the post-distributed processing data into three segments and issuing three processing requests, each corresponding to one of the divided segments, to write to the NVM 24. In other words, each of the instruction destination CPUs 11 configures a single write-processing operation command with three processing requests and implements one write-processing operation with three processing requests.

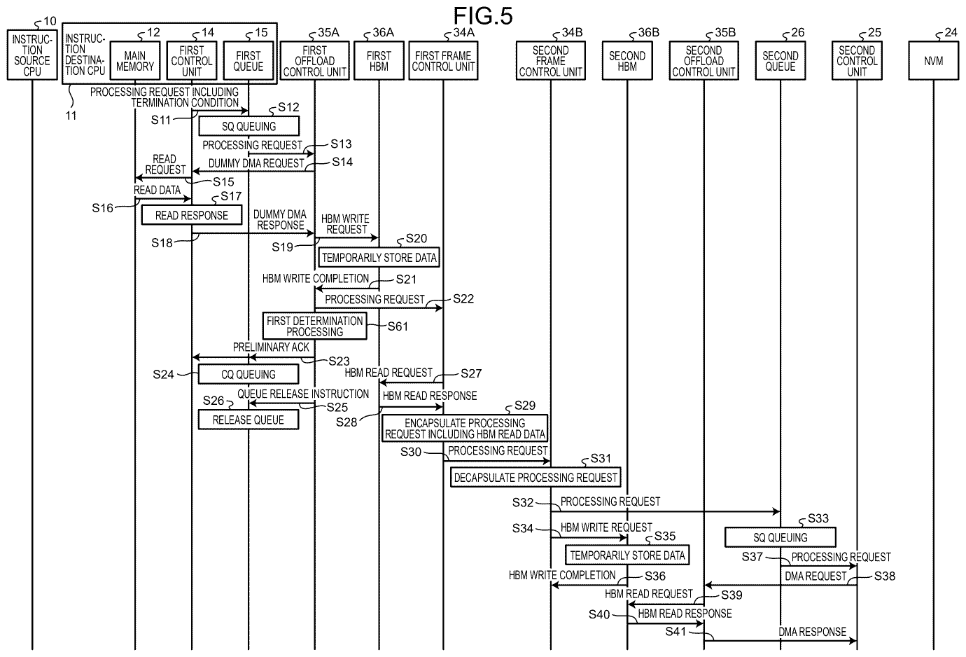

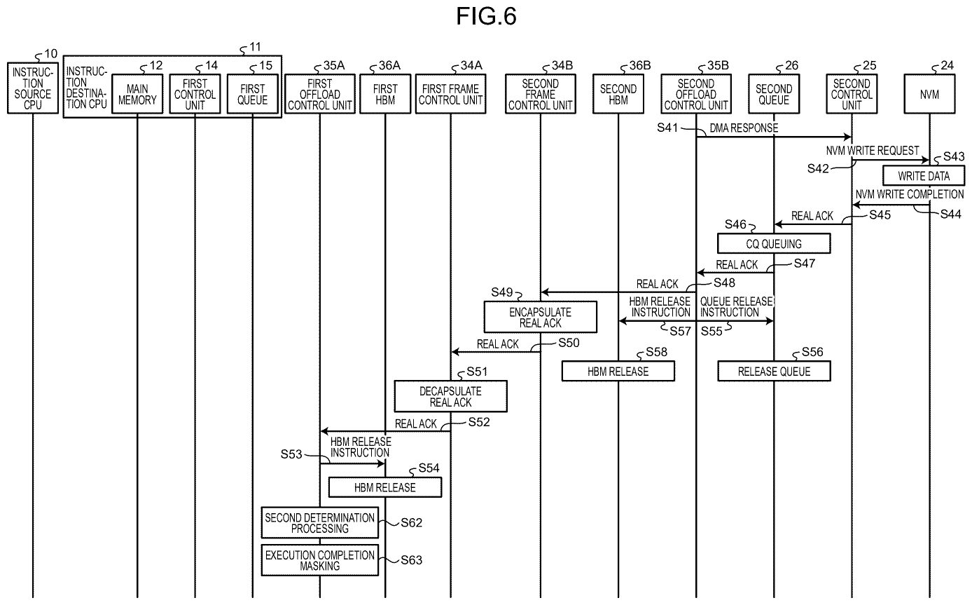

FIGS. 5 and 6 are sequence diagrams illustrating an example of the processing operation related to a first write-processing operation in the optical transmission system 1 according to the first embodiment. The first control unit 14 in the instruction destination CPU 11 issues a processing request, such as an NVMe-oF protocol processing request, for writing write-target data stored in the main memory 12 to the NVM 24. Moreover, for convenience of description, one instance of first write-processing operation is assumed to be implemented with three processing requests. In addition, the processing request includes a termination condition. The termination condition is assumed to include a first threshold used in a first determination processing operation of the first offload control unit 35A and a second threshold used in a second determination processing operation of the second offload control unit 35B, among other parameters.

The first control unit 14 issues a first processing request in response to a command to execute a first write-processing operation. Then, the first control unit 14 notifies the first queue 15 of the issued processing request, i.e., the first processing request (step S11). The first SQ 15A in the first queue 15 performs SQ queuing of the notified processing request (step S12).

The first offload control unit 35A in the first smart NIC 5A detects processing requests queued in the first SQ 15A in accordance with the doorbell function of the first queue 15 (step S13). The first offload control unit 35A sets, among the termination conditions in the detected processing request, the first threshold to be used in the first determination processing and the second threshold to be used in the second determination processing. Moreover, the first threshold corresponds to a later-described threshold used to determine whether to perform masking on a preliminary ACK, i.e., the number of processing requests in the command for executing one instance of the first write-processing operation. The second threshold corresponds to the number of processing requests in the command and is used to determine whether to perform masking on the completion of execution described later. For example, if the number of processing requests included in the command is “3”, both the first and second thresholds are set to “3”.

The first offload control unit 35A notifies the first control unit 14 of a dummy DMA request in response to the detected processing request (step S14). Upon detecting the dummy DMA request, the first control unit 14 issues a read request to the main memory 12 to read the write-target data from the main memory 12 in response to the dummy DMA request (step S15). The main memory 12 reads the write-target data in response to the read request (step S16) and notifies the first control unit 14 of a read response including the write-target data that is read (step S17).

Upon detecting the read response, the first control unit 14 notifies the first offload control unit 35A of a dummy DMA response that includes the write-target data that is read (step S18). Upon detecting the dummy DMA response, the first offload control unit 35A issues an HBM write request to the first HBM 36A including the write-target data contained in the dummy DMA response (step S19). The first HBM 36A temporarily stores the write-target data in the HBM write request in response to the HBM write request (step S20) and notifies the first offload control unit 35A of the completion of the HBM write (step S21). In other words, the first offload control unit 35A reads the write-target data from the main memory 12 in response to the processing request and temporarily stores the write-target data, which is read, into the first HBM 36A.

Further, after detecting the completion of the HBM write, the first offload control unit 35A notifies the first frame control unit 34A of the processing request detected in step S13 (step S22). Upon detecting the processing request, the first frame control unit 34A issues an HBM read request to the first HBM 36A to read the write-target data that is stored in the first HBM 36A (step S27). In response to the HBM read request, the first HBM 36A notifies the first frame control unit 34A of an HBM read response that includes the write-target data that is read (step S28). The first frame control unit 34A encapsulates the processing request including the HBM read response (step S29). The first frame control unit 34A optically converts the encapsulated processing request via the first optical transceiver 31A and optically transmits the optically converted processing request to the second smart NIC 5B through the optical transmission path 4 (step S30). In other words, the first offload control unit 35A reads the write-target data that is temporarily stored in the first HBM 36A and optically transmits the processing request including the write-target data that is read to the second smart NIC 5B as the first handshake.

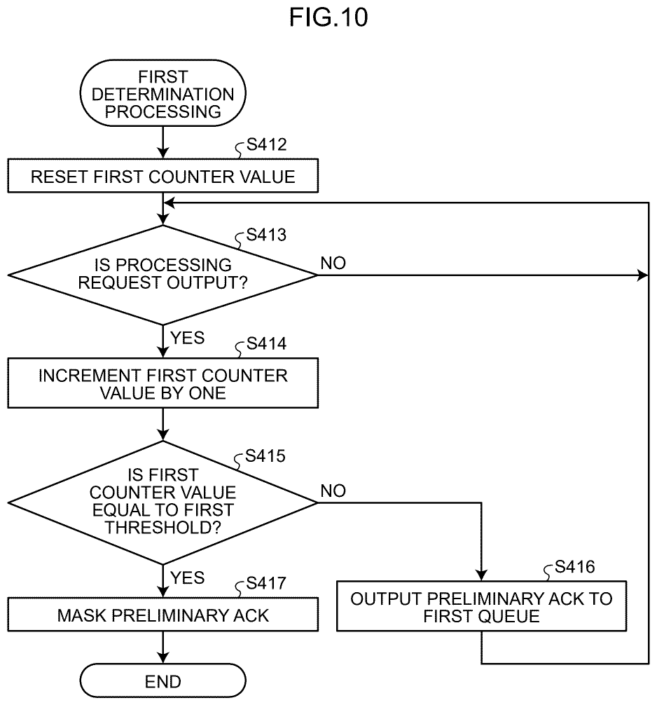

Further, after notifying the first frame control unit 34A of the processing request in step S22, the first offload control unit 35A executes the first determination processing illustrated in FIG. 10 (step S61). The first determination processing is a processing operation for determining whether to perform masking on a preliminary ACK to the first queue 15. Moreover, for convenience of description, masking a preliminary ACK to the first queue 15 includes not outputting a preliminary ACK to the first queue 15, or causing the first queue 15 to ignore the preliminary ACK from the first offload control unit 35A. If it is determined that the processing request is not the final among the multiple processing requests in the command, the first determination processing transfers the preliminary ACK to the first control unit 14 and the first queue 15. Moreover, if there are three processing requests in the command, the final processing request corresponds to the third processing request.

If the first determination processing determines not to perform masking on the preliminary ACK, the first offload control unit 35A notifies the first queue 15 of the preliminary ACK and also notifies the first control unit 14 of the preliminary ACK (step S23). The first CQ 15B in the first queue 15 performs CQ queuing of the notified preliminary ACK (step S24). In addition, after notifying the first queue 15 of the preliminary ACK, the first offload control unit 35A notifies the first queue 15 of a queue release instruction (step S25).

The first queue 15 releases the information regarding the target SQ/CQ pair in response to the queue release instruction (step S26). In other words, the first offload control unit 35A releases the queue of the first queue 15 before the processing request including the write-target data is executed by the second smart NIC 5B.

Further, the first control unit 14, including the case where a preliminary ACK from the first offload control unit 35A is detected in step S23, proceeds to the processing of step S11 to issue the next processing request, for example, a second processing request, until the final processing request is issued.

The second frame control unit 34B in the second smart NIC 5B electrically converts the encapsulated processing request via the second optical transceiver 31B and decapsulates the electrically converted processing request to separate the decapsulated processing request into the processing request and the write-target data (step S31). The second frame control unit 34B notifies the second queue 26 in the controller 23 of the separated processing request (step S32). The second SQ 26A in the second queue 26 performs SQ queuing in response to the processing request (step S33). In addition, the second frame control unit 34B issues an HBM write request to the second HBM 36B to write the separated write-target data into the second HBM 36B (step S34).

The second HBM 36B temporarily stores the write-target data included in the HBM write request in response to the HBM write request (step S35) and notifies the second offload control unit 35B of the completion of the HBM write (step S36).

The second control unit 25, in accordance with the doorbell function of the second queue 26, detects a processing request queued in the second SQ 26A (step S37). The second control unit 25 notifies the second offload control unit 35B of a DMA request in response to the detected processing request (step S38). The second offload control unit 35B, in response to the DMA request, issues an HBM read request to the second HBM 36B to read the write-target data from the second HBM 36B (step S39). The second HBM 36B reads the write-target data in response to the HBM read request and notifies the second offload control unit 35B of an HBM read response including the write-target data that is read (step S40). Upon detecting the HBM read response, the second offload control unit 35B notifies the second control unit 25 of a DMA response including the write-target data that is read, as illustrated in FIG. 5 (step S41). In other words, the second control unit 25 is capable of retrieving the write-target data from the second HBM 36B in response to the DMA request.

In FIG. 6, the second control unit 25 issues an NVM write request to the NVM 24 in response to the DMA response, to write the write-target data contained in the DMA response into the NVM 24 (step S42). The NVM 24 writes the write-target data in response to the NVM write request (step S43), and after the completion of the write, notifies the second control unit 25 of the completion of the NVM write (step S44). Upon detecting the completion of the NVM write, the second control unit 25 notifies the second queue 26 of a real ACK indicating a processing completion flag (step S45). The second CQ 26B in the second queue 26 performs CQ queuing in response to the real ACK (step S46).

The second offload control unit 35B detects the real ACK of the second CQ 26B in accordance with the doorbell function of the second queue 26 (step S47). The second offload control unit 35B notifies the second frame control unit 34B of the detected real ACK (step S48). Upon detecting the real ACK from the second offload control unit 35B, the second frame control unit 34B encapsulates the real ACK (step S49). The second frame control unit 34B optically converts the encapsulated real ACK via the second optical transceiver 31B and optically transmits the optically converted real ACK to the first smart NIC 5A through the optical transmission path 4 (step S50). Moreover, the processing completion flag in step S50 corresponds to the second handshake. However, since the information regarding the SQ/CQ pair targeted by the first queue 15 has already been released in step S26, there is no impact on the throughput on the side of the host CPU 111.

The first frame control unit 34A in the first smart NIC 5A electrically converts the encapsulated real ACK via the first optical transceiver 31A and decapsulates the electrically converted real ACK (step S51). Furthermore, the first frame control unit 34A notifies the first offload control unit 35A of the decapsulated real ACK (step S52). The first offload control unit 35A issues an HBM release instruction to the first HBM 36A in response to the real ACK (step S53). Then, in response to the HBM release instruction, the first HBM 36A executes HBM release to erase the write-target data (step S54). As a result, the first HBM 36A is capable of erasing the write-target data in response to the HBM release instruction.

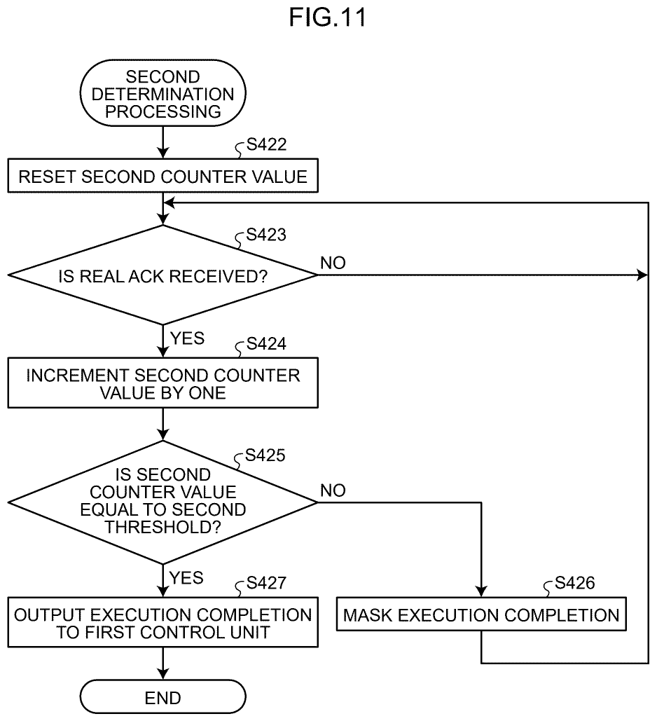

After issuing an HBM release instruction to the first HBM 36A in step S53 in response to the real ACK, the first offload control unit 35A executes the second determination processing illustrated in FIG. 11 (step S62). The second determination processing is a processing operation for determining whether a real ACK for the final processing request is received.

If, in the second determination processing of step S62, the first offload control unit 35A determines that the received real ACK does not correspond to the final processing request, the first offload control unit 35A determines that the real ACK is for a processing request other than the final processing request. Then, the first offload control unit 35A performs masking on the completion of execution to the first queue 15 and the first control unit 14 (step S63) and continues the processing of step S11. Moreover, for convenience of description, masking the completion of execution to the first control unit 14 includes not outputting the completion of execution to the first control unit 14 or causing the first control unit 14 to ignore the completion of execution from the first offload control unit 35A. As a result, the first control unit 14 does not receive the completion of execution from the first offload control unit 35A, thereby avoiding notification of the distributed processing completion to the instruction source CPU 10.

Further, after notifying the second frame control unit 34B of the real ACK in step S48, the second offload control unit 35B notifies the second queue 26 of a queue release instruction (step S55). Then, the second queue 26 releases the information regarding the target SQ/CQ pair (step S56).

Further, after notifying the second frame control unit 34B of the real ACK in step S48, the second offload control unit 35B notifies the second HBM 36B of an HBM release instruction (step S57). The second HBM 36B executes HBM release to erase the write-target data in response to the HBM release instruction (step S58), and proceeds to processing of step S11. As a result, the second HBM 36B is capable of erasing the write-target data in response to the HBM release instruction.

Moreover, in the optical transmission system 1, while an example is illustrated in which a plurality of processing requests, or a plurality of processing requests obtained by dividing a single processing request, are included in a command for distributed processing, in a case where no distributed processing is performed and a single processing request in the command is processed, the write processing illustrated in FIGS. 36 and 37 of the optical transmission system 200 according to the fifth embodiment is executed.

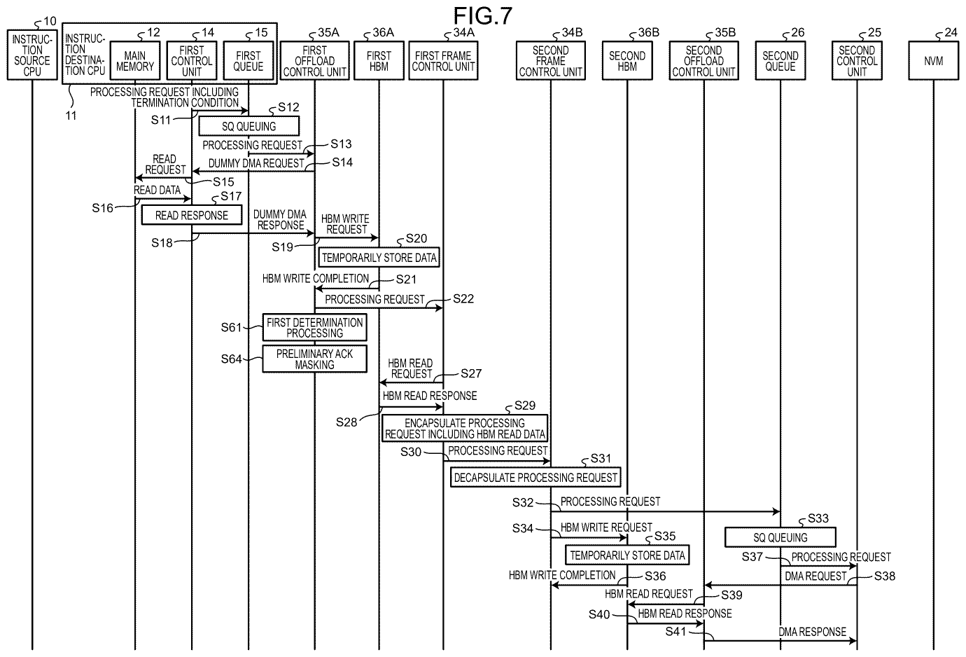

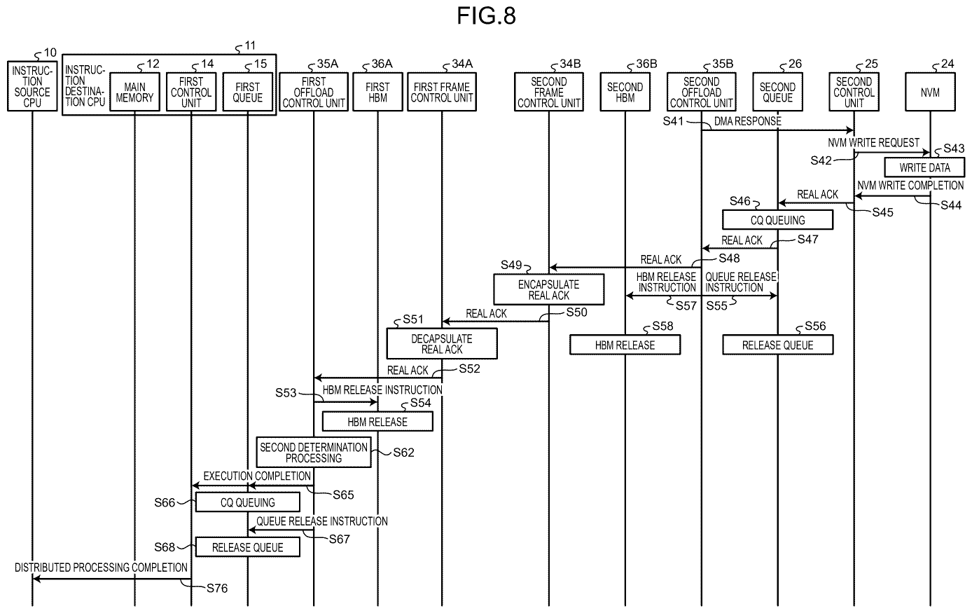

FIGS. 7 and 8 are sequence diagrams illustrating an example of processing operations related to the first write-processing operation in the optical transmission system 1 according to the first embodiment. Moreover, for convenience of description, the same reference numerals are assigned to identical operations as those in the first write-processing operation of FIGS. 5 and 6, and the description of the duplicate operations is omitted. In FIG. 7, the first offload control unit 35A, after notifying the first frame control unit 34A of a processing request in step S22, executes the first determination processing illustrated in FIG. 10 in step S61.

If, in the first determination processing, the first offload control unit 35A determines that the processing request is the final processing request, the first offload control unit 35A performs masking on the preliminary ACK to the first queue 15 (step S64). As a result, masking the preliminary ACK to the first queue 15 prevents the queue of the first queue 15 from being released.

Further, in FIG. 8, the first offload control unit 35A determines, in the second determination processing of step S62, that the received real ACK corresponds to the final processing request and notifies the first queue 15 and the first control unit 14 of the completion of execution (step S65). The first CQ 15B in the first queue 15 performs CQ queuing in response to the notified execution completion (step S66). In addition, after notifying the first queue 15 of the completion of execution, the first offload control unit 35A notifies the first queue 15 of a queue release instruction (step S67).

The first queue 15 releases the information regarding the target SQ/CQ pair in response to the queue release instruction (step S68). In other words, the first offload control unit 35A determines that all processing requests including the write-target data in the second smart NIC 5B are completed, and releases the queue of the first queue 15.

Upon detecting the completion of execution in step S65, the first control unit 14 determines that all processing requests in the command for the first write-processing operation have been executed, and notifies the instruction source CPU 10 of the completion of distributed processing (step S76). In other words, upon detecting the completion of execution for the third processing request, the first control unit 14 determines that the three processing requests in the command for the first write-processing operation have been executed, and notifies the instruction source CPU 10 of the completion of distributed processing. As a result, the instruction source CPU 10 is capable of recognizing that the first write-processing operations in the instruction destination CPUs 11 have been completed.

Upon receiving the notification of completion of distributed processing from all of the instruction destination CPUs 11, the instruction source CPU 10 determines that the first write-processing operation related to the distributed processing in all of the instruction destination CPUs 11 is completed. Thus, the instruction source CPU 10 is capable of implementing data roll-up processing to read the data after the first write-processing operation from each of the instruction destination CPUs 11.

Upon detecting issuance of a processing request from the first control unit 14, the first smart NIC 5A reads the write-target data corresponding to the processing request from the main memory 12 and stores the write-target data in the first HBM 36A. The first smart NIC 5A optically transmits the processing request, including the write-target data stored in the first HBM 36A, to the storage server 3 as the first handshake. Until the timing at which the final processing request is output, the first smart NIC 5A, before executing the processing requests on the storage server 3 side, performs CQ queuing and releases the preliminary ACK for the processing requests in the first CQ 15B.

Upon detecting a processing request from the first smart NIC 5A, the second smart NIC 5B performs SQ queuing of the processing request in the second SQ 26A and stores the write-target data in the second HBM 36B. The second control unit 25 stores the write data stored in the second HBM 36B into the NVM 24 in response to the processing request in the second SQ 26A. Then, upon completing storing the write-target data in the NVM 24, the second control unit 25 performs CQ queuing of a real ACK for the processing request in the second CQ 26B and releases the real ACK. Furthermore, the second smart NIC 5B optically transmits the real ACK to the compute server 2 as a second handshake. Then, the first smart NIC 5A releases the first HBM 36A in response to the real ACK.

In other words, in the optical transmission system 1, from SQ queuing to the release of the information regarding the SQ/CQ pair, only a single handshake of the processing request between the compute server 2 and the storage server 3 is sufficient for one processing request of step S30. This makes it possible to shorten the transmission latency related to each processing request. Specifically, without increasing the number of CPU cores, it is possible to implement the optical transmission system 1 for NVMe-oF that is suitable for long-distance transmission and capable of improving processing delay including transmission latency.

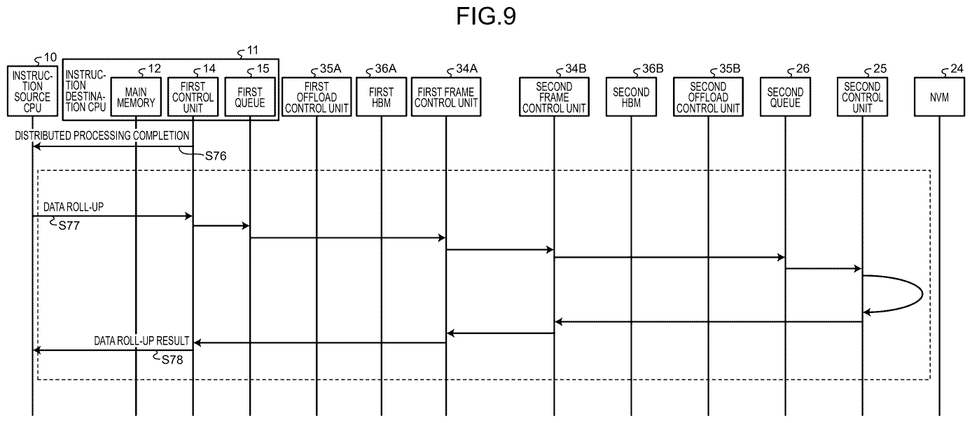

FIG. 9 is a sequence diagram illustrating an example of the processing operation related to the data roll-up processing in the optical transmission system 1 according to the first embodiment. In the case where the first control unit 14 in each of the instruction destination CPUs 11 detects the completion of execution from the first offload control unit 35A, the first control unit 14 transmits a distributed processing completion notification to the instruction source CPU 10 (step S76).

Subsequently, upon receiving the distributed processing completion notification from all of the instruction destination CPUs 11, the instruction source CPU 10 determines that the post-write processing data from all of the instruction destination CPUs 11 is written to the high-bandwidth SSD 22 and that all of the distributed processing is complete.

Subsequently, the instruction source CPU 10 issues a data roll-up request to the high-bandwidth SSD 22 to read the post-write processing data written to the high-bandwidth SSD 22 (step S77). The data roll-up request is transmitted from the instruction source CPU 10 to the high-bandwidth SSD 22 via a different route, without passing through the instruction destination CPU 11. The high-bandwidth SSD 22 reads the post-write processing data in response to the data roll-up request and transmits the read post-write processing data to the instruction source CPU 10 as the data roll-up result (step S78). The data roll-up result is transmitted from the high-bandwidth SSD 22 to the instruction source CPU 10 via a different route, without passing through the instruction destination CPU 11. As a result, the instruction source CPU 10 is capable of reading the post-write processing data of each of the instruction destination CPUs 11.

FIG. 10 is a flowchart illustrating an example of the processing operation related to the first determination processing in the first offload control unit 35A. In FIG. 10, the first offload control unit 35A resets a first counter value that counts the number of times the processing request in step S22 is output (step S412). After resetting the first counter value, the first offload control unit 35A determines whether the processing request of step S22 is output to the first frame control unit 34A (step S413). If the processing request is output (step S413: Yes), the first offload control unit 35A increments the first counter value, which counts the number of processing requests output, by one (step S414).

The first offload control unit 35A determines whether the first counter value is equal to the first threshold (step S415). Moreover, the first threshold corresponds to the total number of processing requests in the command for the first write-processing operation. If the first counter value is not equal to the first threshold (step S415: No), the first offload control unit 35A determines that the current processing request is not the final processing request in the first write-processing operation and outputs a preliminary ACK to the first queue 15 (step S416). Then, the first offload control unit 35A proceeds to step S413 to determine whether the next processing request is output.

Further, if the first counter value is equal to the first threshold (step S415: Yes), the first offload control unit 35A determines that the current processing request is the final processing request in the command for the first write-processing operation. Then, the first offload control unit 35A performs masking on the preliminary ACK to the first queue 15 (step S417) and terminates the processing operation illustrated in FIG. 10.

Further, if the first offload control unit 35A does not output a processing request (step S413: No), the first offload control unit 35A proceeds to step S413 to determine whether the processing request is output.

In the first determination processing, in the case where the number of processing requests in the command for the first write-processing operation is counted and the first counter value is not the first threshold, the preliminary ACK is output to the first queue 15 and the first queue 15 is released. Furthermore, in the first determination processing, if the first counter value is equal to the first threshold, the preliminary ACK is masked in the first determination processing. As a result, the output of the preliminary ACK to the first queue 15 until the final processing request is output accelerates queuing release and thereby improves throughput. In addition, masking the preliminary ACK to the first queue 15 in the case where the final processing request is output makes it possible to avoid a situation in which the access order during data roll-up is reversed.

FIG. 11 is a flowchart illustrating an example of the processing operation related to the second determination processing in the first offload control unit 35A. In FIG. 11, the first offload control unit 35A resets a second counter value that counts the number of times a real ACK is received in step S52 (step S422). After resetting the second counter value, the first offload control unit 35A determines whether a real ACK is received in step S52 (step S423).

If a real ACK is received (step S423: Yes), the first offload control unit 35A increments the second counter value by one (step S424).

The first offload control unit 35A determines whether the second counter value is equal to a second threshold (step S425). Moreover, the second threshold corresponds to the total number of processing requests in the command for the first write-processing operation. If the second counter value is not equal to the second threshold (step S425: No), the first offload control unit 35A performs masking on the completion of execution to the first control unit 14 (step S426). Then, the first offload control unit 35A proceeds to step S423 to determine whether the next real ACK is received.

Further, if the second counter value is equal to the second threshold (step S425: Yes), the first offload control unit 35A determines that the real ACK corresponds to the final processing request, outputs the completion of execution to the first control unit (step S427) and terminates the processing operation illustrated in FIG. 11.

Further, if a real ACK is not received (step S423: No), the first offload control unit 35A proceeds to step S423 to determine whether a real ACK is received.

In the second determination processing, if the second counter value representing the number of received real ACKs is equal to the second threshold, it is determined that the real ACK corresponds to the final processing request, and the completion of execution is notified to the first control unit 14. In the second determination processing, if the second counter value is not equal to the second threshold, it is determined that the real ACK does not correspond to the final processing request, and the execution completion notification to the first control unit 14 is masked. As a result, the first offload control unit 35A is capable of notifying the first control unit 14 of the completion of execution in response to the real ACK for the final processing request.

In the optical transmission system 1 according to the first embodiment, it is possible to avoid a situation in which the first control unit 14 is erroneously notified of the completion of execution despite the fact that the processing request has not actually written data to the NVM 24 in the high-bandwidth SSD 22. As a result, the instruction source CPU 10 is capable of ensuring the access order upon reading the data after the write-processing operation to the NVM 24 during data roll-up.

The first offload control unit 35A notifies the first control unit 14 in the instruction destination CPU 11 of the completion of execution for the command in the case where a real ACK corresponding to the final processing request among multiple processing requests in the command is received. As a result, the instruction destination CPU 11 recognizes that all processing requests in the command are completed. Then, upon detecting the completion of execution, the instruction destination CPU 11 notifies the instruction source CPU 10 of the completion of the distributed processing. Accordingly, the instruction source CPU 10 determines that the distributed processing is complete upon detecting the completion of distributed processing from all of the instruction destination CPUs 11, thereby ensuring the access order during data roll-up.

The first offload control unit 35A performs masking on the completion of execution for the command in the case where a real ACK corresponding to a processing request other than the final processing request is received. As a result, the instruction destination CPU 11 recognizes that all processing requests in the command are completed.

The first offload control unit 35A counts the number of real ACKs received for a processing request, determines whether the number of received real ACKs matches the number of processing requests in the command, and if they match, determines that a real ACK for the final processing request has been received. As a result, the instruction destination CPU 11 recognizes that all processing requests in the command are completed.

The first offload control unit 35A determines whether the processing request in the command is the final processing request, and if the processing request is not the final processing request, notifies the first queue 15 of a preliminary ACK for the processing request. As a result, until the final processing request is output, queue release of the first queue 15 can be accelerated, thereby improving throughput.

If the processing request in the command is the final processing request, the first offload control unit 35A performs masking on the preliminary ACK for the processing request to the first queue 15. As a result, masking the preliminary ACK to the first queue 15 makes it possible to prevent a situation in which the access order during data roll-up is reversed.

Upon detecting the issuance of a processing request, the instruction destination CPU 11 queues the processing request in the first queue 15. After requesting the notification of the processing request to the second offload control unit 35B, and before executing the processing request in the high-bandwidth SSD 22, the instruction destination CPU 11 queues the preliminary ACK for the processing request in the first queue 15 and releases the queue for the preliminary ACK for the processing request. As a result, until the final processing request is output, queue release of the first queue 15 can be accelerated, thereby improving throughput in the event of congestion in long-distance communication.

The optical transmission system 1 includes the multiple instruction destination CPUs 11 and the instruction source CPU 10 connected in parallel to the multiple instruction destination CPUs 11 and transmitting higher-level commands, such as distributed processing instructions, to each of the instruction destination CPUs 11 in parallel. Each of the instruction destination CPUs 11, Upon receiving a higher-level command, issues a command and transmits the command to the high-bandwidth SSD 22. The instruction source CPU 10, upon receiving the completion of execution from all of the instruction destination CPUs 11, determines that the distributed processing is complete. Accordingly, the instruction source CPU 10 determines that the distributed processing is complete upon detecting the completion of distributed processing from all of the instruction destination CPUs 11, thereby ensuring the access order during data roll-up.

Further, in the first determination processing, the case is illustrated in which whether to perform masking on the preliminary ACK is determined based on whether the first counter value is equal to the first threshold. However, for example, it is also possible to measure a timer duration corresponding to the first counter value from the start of outputting the processing requests, and determine whether to perform masking on the preliminary ACK based on whether the timer duration has reached a predetermined time corresponding to the first threshold, and this approach can be modified as appropriate.

Further, in the second determination processing, the case is illustrated in which whether to perform masking on the completion of execution is determined based on whether the second counter value is equal to the second threshold. However, for example, it is also possible to measure a timer duration corresponding to the second counter value from the start of receiving the real ACK, and to determine whether to perform masking on the completion of execution based on whether the timer duration has reached a predetermined time corresponding to the second threshold, and this approach can be modified as appropriate.

In the optical transmission system 1 according to the first embodiment, the case is illustrated in which whether to perform masking on the completion of execution to the first control unit 14 is determined in the second determination processing based on the second counter value, which represents the number of real ACKs received from the second offload control unit 35B. However, embodiments of the present disclosure are not limited to the exemplary embodiment herein and can be modified as appropriate.

Thus, another embodiment is described below as a second embodiment. Note that, for components and operations identical to those in the optical transmission system 1 according to the first embodiment, the same reference numerals are used, and repeated descriptions are omitted.

### (e) Second Embodiment

The second offload control unit 35B, upon transmitting a real ACK to the first smart NIC 5A, stores, in the real ACK, a completion flag used as an identifier identifying whether the real ACK corresponds to the final processing request in the second write-processing operation. In the case where the real ACK corresponds to the final processing request in the second write-processing operation, the second offload control unit 35B sets the completion flag to “1” to be stored in the real ACK. If the real ACK does not correspond to the final processing request in the second write-processing operation, the second offload control unit 35B sets the completion flag of “0” to be stored in the real ACK.

The first offload control unit 35A, upon receiving a real ACK, determines whether to perform masking on the completion of execution to the first control unit 14 based on the presence or absence of the completion flag in the real ACK. If the completion flag in the real ACK is “1”, the first offload control unit 35A notifies the first control unit 14 of the completion of execution. If the completion flag in the real ACK is “0”, the first offload control unit 35A performs masking on the completion of execution to the first control unit 14.

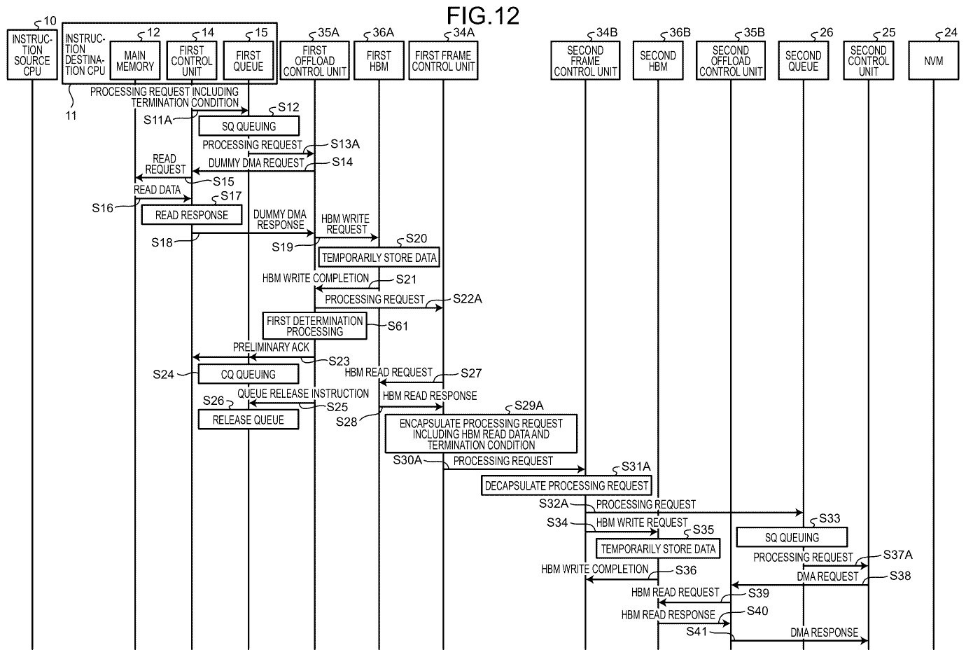

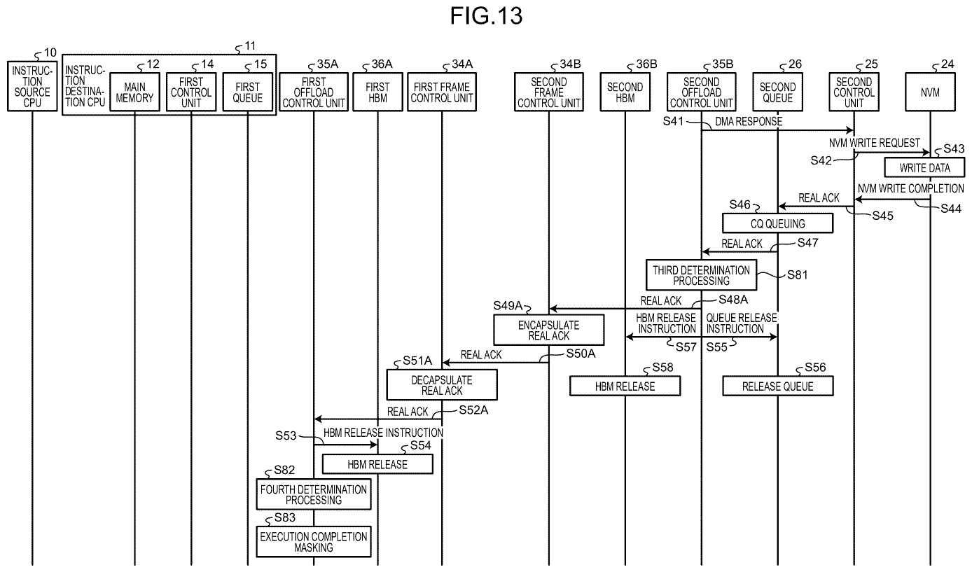

FIGS. 12 and 13 are sequence diagrams illustrating an example of the processing operation related to the second write-processing operation in an optical transmission system 1A according to the second embodiment. Moreover, for convenience of description, one instance of the second write-processing operation is assumed to be implemented using, for example, three processing requests. The first control unit 14 issues the first processing request in response to a command to execute the second write-processing operation. The first control unit 14 in the instruction destination CPU 11 notifies the first queue of a processing request including a termination condition, i.e., the first processing request (step S11A). Moreover, it is assumed that the termination condition includes, for example, a first threshold used in the first determination processing, a third threshold and completion flag setting used in the third determination processing, and a determination criterion for the completion flag used in the fourth determination processing.

The first offload control unit 35A in the first smart NIC 5A detects the processing request that includes the termination condition currently queued in the first SQ 15A in accordance with the doorbell function of the first queue 15 (step S13A) and proceeds to the processing of step S14. The first offload control unit 35A sets the first threshold to be used in the first determination processing and the determination criterion to be used in the fourth determination processing, among the termination conditions in the detected processing request. Moreover, the determination criterion is a parameter for determining whether to perform masking on the completion of execution, as described below.

Further, the first offload control unit 35A, after detecting the completion of the HBM write in step S21, notifies the first frame control unit 34A of the processing request including the termination condition detected in step S13A (step S22A).

Further, the first frame control unit 34A, upon detecting an HBM read response in step S28, encapsulates the processing request including the HBM read data and the termination condition (step S29A). The first frame control unit 34A optically converts the encapsulated processing request via the first optical transceiver 31A and optically transmits the optically converted processing request to the second smart NIC 5B through the optical transmission path 4 (step S30A). In other words, the first offload control unit 35A reads the write-target data that is temporarily stored in the first HBM 36A and optically transmits the processing request including the write-target data that is read and the termination condition to the second smart NIC 5B as the first handshake.

Further, the first offload control unit 35A, after notifying the first frame control unit 34A of the processing request in step S22A, executes the first determination processing in step S61.

Further, the second frame control unit 34B in the second smart NIC 5B electrically converts the encapsulated processing request including the termination condition via the second optical transceiver 31B. The second frame control unit 34B decapsulates the electrically converted processing request and separates the decapsulated processing request into the processing request including the termination condition and the write-target data (step S31A). The second frame control unit 34B notifies the second queue 26 in the controller 23 of the separated processing request (step S32A) and proceeds to the processing of step S33.

Further, the second control unit 25 detects the processing requests queued in the second SQ 26A in accordance with the doorbell function of the second queue 26 (step S37A). Moreover, the second offload control unit 35B, upon detecting the processing request, also sets a third threshold and a completion flag setting criterion to be used in the third determination processing among the termination conditions in the detected processing request. Moreover, the third threshold is a threshold used for determining whether the real ACK corresponds to the final processing request, i.e., corresponds to the total number of processing requests in the command that executes one instance of the second write-processing operation. For example, if the total number of processing requests in the command is “3”, the third threshold is “3”. The setting criterion is a criterion for storing a completion flag of “1” or “0” in the real ACK.

In FIG. 13, the second offload control unit 35B executes the third determination processing in response to the real ACK from the second queue 26 in step S47 (step S81). In the third determination processing, it is determined whether the real ACK corresponds to the final processing request among the multiple processing requests in the command. Then, in the third determination processing, if the real ACK corresponds to the final processing request, the real ACK including a completion flag of “1” is output, and if the real ACK does not correspond to the final processing request, the real ACK including a completion flag of “0” is output.

The second offload control unit, if it is determined in step S81 that the real ACK does not correspond to the final processing request, notifies the second frame control unit 34B of the real ACK including the completion flag of “0” (step S48A).

The second frame control unit 34B, upon detecting the real ACK from the second offload control unit 35B, encapsulates the real ACK including the completion flag of “0” (step S49A). The second frame control unit 34B optically converts the encapsulated real ACK via the second optical transceiver 31B and optically transmits the optically converted real ACK to the first smart NIC 5A through the optical transmission path 4 (step S50A). The real ACK including the completion flag in step S50A corresponds to the second handshake. However, since the information regarding the SQ/CQ pair targeted by the first queue 15 has already been released in step S26, it does not affect the throughput on the side of the instruction destination CPU 11.

The first frame control unit 34A in the first smart NIC 5A electrically converts the encapsulated real ACK via the first optical transceiver 31A and decapsulates the electrically converted real ACK (step S51A). Furthermore, the first frame control unit 34A notifies the first offload control unit 35A of the decapsulated real ACK (step S52A).

The first offload control unit 35A, in response to the real ACK in step S53, requests the first HBM 36A to issue an HBM release instruction. Then, in step S54, the first HBM 36A executes HBM release by erasing the write-target data in response to the HBM release instruction. As a result, the first HBM 36A is capable of erasing the write-target data in response to the HBM release instruction.

The first offload control unit 35A executes fourth determination processing (step S82). In the fourth determination processing, the completion flag in the real ACK is identified, and if the identified completion flag is “0”, the completion of execution is masked to the first control unit 14, whereas if the identified completion flag is “1”, the completion of execution is notified to the first control unit 14. The first offload control unit 35A, if the completion flag in the real ACK is “0” in step S82, performs masking on the completion of execution to the first control unit 14 (step S83) and proceeds to the processing of step S11A. As a result, the first control unit 14 does not receive the completion of execution from the first offload control unit 35A, thereby avoiding notification of the distributed processing completion to the instruction source CPU 10.

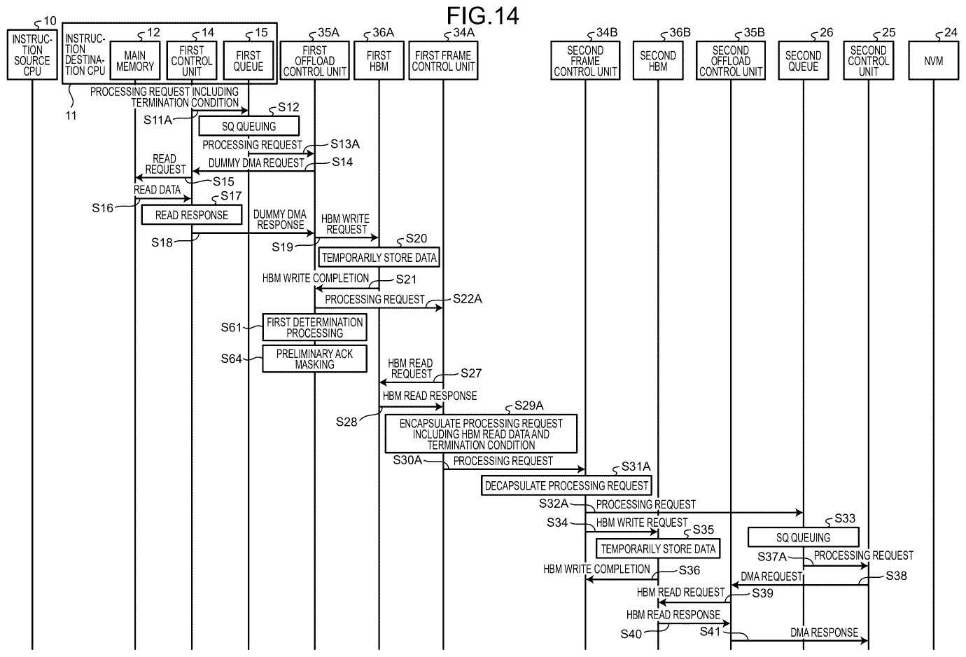

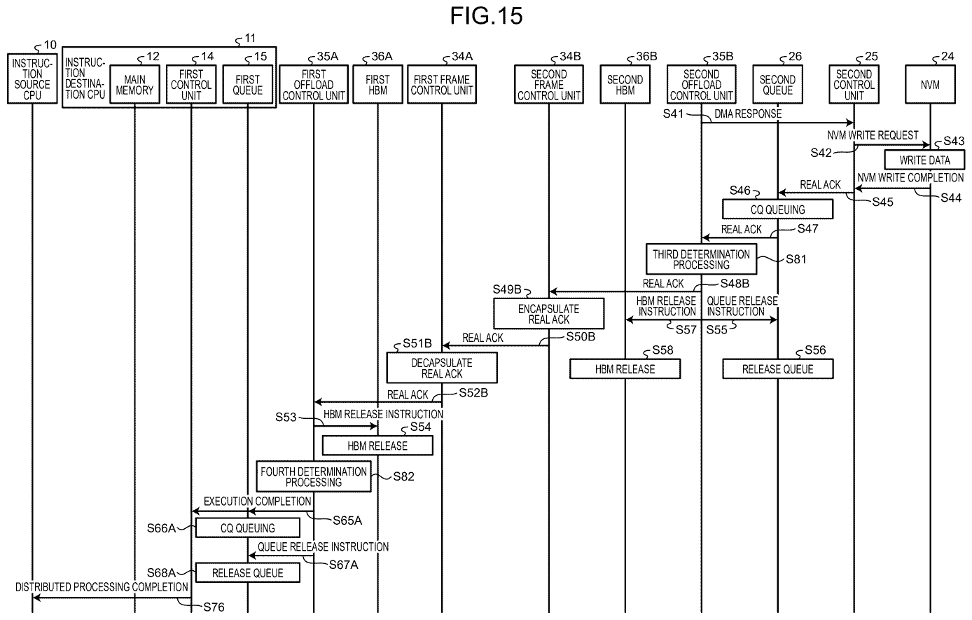

FIGS. 14 and 15 are sequence diagrams illustrating an example of the processing operation related to the second write-processing operation in the optical transmission system 1A according to the second embodiment. In FIG. 14, the first offload control unit 35A notifies the first frame control unit 34A of a processing request in step S22A, and then executes the first determination processing (step S61). If, in the first determination processing, the first offload control unit 35A determines that the processing request is the final processing request, the first offload control unit 35A performs masking on the preliminary ACK to the first queue 15 (step S64). As a result, masking the preliminary ACK to the first queue 15 prevents the first queue 15 from being released.

In FIG. 15, the second offload control unit 35B executes the third determination processing in response to the real ACK from the second queue 26 in step S47 (step S81). The second offload control unit 35B, if it is determined in step S81 that the real ACK corresponds to the final processing request, notifies the second frame control unit 34B of the real ACK including the completion flag of “1” (step S48B).

The second frame control unit 34B, upon detecting the real ACK from the second offload control unit 35B, encapsulates the real ACK including the completion flag of “1” (step S49B). The second frame control unit 34B optically converts the encapsulated real ACK via the second optical transceiver 31B and optically transmits the optically converted real ACK to the first smart NIC 5A through the optical transmission path 4 (step S50B). Moreover, the real ACK in step S50B corresponds to the second handshake. However, since the information regarding the SQ/CQ pair targeted by the first queue 15 has already been released in step S26, it does not affect the throughput on the side of the instruction destination CPU 11.

The first frame control unit 34A in the first smart NIC 5A electrically converts the encapsulated real ACK via the first optical transceiver 31A and decapsulates the electrically converted real ACK (step S51B). Furthermore, the first frame control unit 34A notifies the first offload control unit 35A of the decapsulated real ACK (step S52B). The first offload control unit 35A executes fourth determination processing (step S82).

The first offload control unit 35A, if the completion flag in the real ACK is “1” in step S82, notifies the first queue 15 and the first control unit 14 of the completion of execution (step S65A). The first CQ 15B in the first queue 15 performs CQ queuing of the notified completion of execution (step S66A). In addition, the first offload control unit 35A, after notifying the first queue 15 of the completion of execution, notifies the first queue 15 of a queue release instruction (step S67A).

The first queue 15, in response to the queue release instruction, releases the information regarding the target SQ/CQ pair (step S68A). In other words, the first offload control unit 35A determines that all processing requests including the write-target data in the second smart NIC 5B are completed, and releases the queue of the first queue 15.

Then, the first control unit 14, upon detecting the completion of execution of step S65A, determines that all processing requests in the command for the second write-processing operation have been executed and notifies the completion of the distributed processing to the instruction source CPU 10 (step S76). In other words, the first control unit 14, upon detecting the completion of execution for the third processing request, determines that all three processing requests in the command for the second write-processing operation have been executed, and notifies the instruction source CPU 10 of the completion of the distributed processing. As a result, it is possible for the instruction source CPU 10 to recognize the completion of the second write-processing operation in the instruction destination CPU 11.

The instruction source CPU 10, upon receiving the notification of distributed processing completion from all of the instruction destination CPUs 11, determines that the second write-processing operation related to the distributed processing at all of the instruction destination CPUs 11 has been completed. The instruction source CPU 10 is thus able to perform the data roll-up processing to read the data after the second write-processing operation from each of the instruction destination CPUs 11.

Upon detecting issuance of a processing request from the first control unit 14, the first smart NIC 5A reads the write-target data corresponding to the processing request from the main memory 12 and stores the write-target data in the first HBM 36A. The first smart NIC 5A optically transmits the processing request, including the write-target data stored in the first HBM 36A, to the storage server 3 as the first handshake. Until the timing at which the final processing request is output, the first smart NIC 5A, before executing the processing requests on the storage server 3 side, performs CQ queuing and releases the preliminary ACK for the processing requests in the first CQ 15B.

Upon detecting a processing request from the first smart NIC 5A, the second smart NIC 5B performs SQ queuing of the processing request in the second SQ 26A and stores the write-target data in the second HBM 36B. The second control unit 25 stores the write data stored in the second HBM 36B into the NVM 24 in response to the processing request in the second SQ 26A. Then, upon completing storing the write-target data in the NVM 24, the second control unit 25 performs CQ queuing of a real ACK for the processing request in the second CQ 26B and releases the real ACK. Furthermore, the second smart NIC 5B optically transmits the real ACK to the compute server 2 as a second handshake. Then, the first smart NIC 5A releases the first HBM 36A in response to the real ACK.

In other words, in the optical transmission system 1A, from the SQ queuing to the release of the information regarding the SQ/CQ pair, only one handshake for a single processing request between the compute server 2 and the storage server 3 is sufficient as in step S30A. This makes it possible to shorten the transmission latency related to each processing request. Specifically, without increasing the number of CPU cores, it is possible to implement the optical transmission system 1 for NVMe-oF that is suitable for long-distance transmission and capable of improving processing delay including transmission latency.

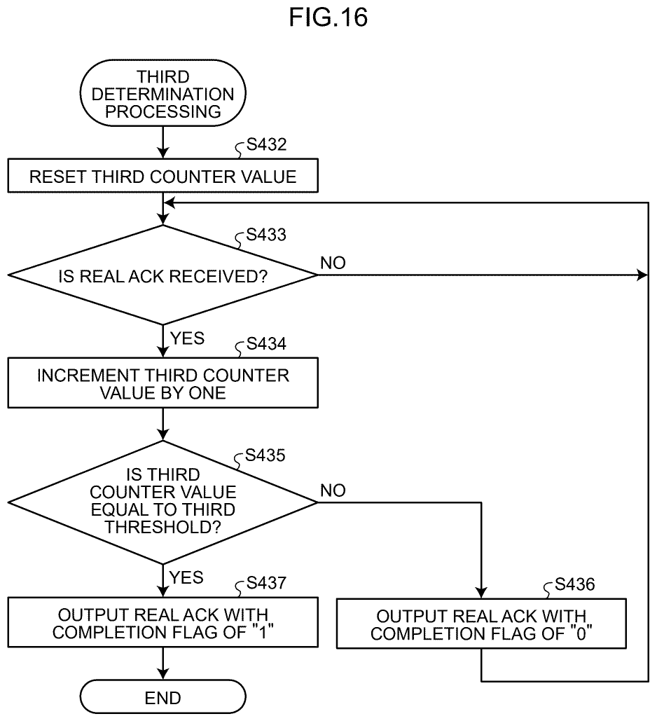

FIG. 16 is a flowchart illustrating an example of the processing operation related to the third determination processing in the second offload control unit 35B. In FIG. 16, the second offload control unit 35B resets a third counter value that counts the number of real ACKs received in step S47 (step S432). The second offload control unit 35B, after resetting the third counter value, determines whether a real ACK is received from the second queue 26 in step S47 (step S433).

The second offload control unit 35B, if the real ACK is received in step S47 (step S433: Yes), increments the third counter value by one (step S434).

The second offload control unit 35B determines whether the third counter value is the third threshold (step S435). The third threshold corresponds to the total number of processing requests in the command for the second write-processing operation. If the third counter value does not match the third threshold (step S435: No), the second offload control unit 35B determines that the received real ACK does not correspond to the final processing request among the multiple processing requests. Then, the second offload control unit 35B outputs a real ACK including the completion flag of “0” to the second frame control unit 34B (step S436). Then, the second offload control unit 35B terminates the processing operation illustrated in FIG. 16.

Further, if the third counter value matches the third threshold (step S435: Yes), the second offload control unit 35B determines that the received real ACK corresponds to the final processing request among the multiple processing requests. Then, the second offload control unit 35B outputs a real ACK including the completion flag of “1” to the second frame control unit 34B (step S437). Then, the second offload control unit 35B terminates the processing operation illustrated in FIG. 16.

Further, if no real ACK is received (step S433: No), the second offload control unit 35B proceeds to step S433 to determine whether a real ACK is received.

In the third determination processing, if the third counter value, which is the number of the received real ACKs, is equal to the third threshold, it is determined that the received real ACK corresponds to the final processing request, and a real ACK including the completion flag of “1” is output. On the other hand, in the third determination processing, if the third counter value is not equal to the third threshold, it is determined that the real ACK does not correspond to the final processing request, and a real ACK including the completion flag of “0” is output. As a result, it is possible for the first offload control unit 35A to determine whether the real ACK corresponds to the final processing request based on the completion flag, without counting the number of received real ACKs.

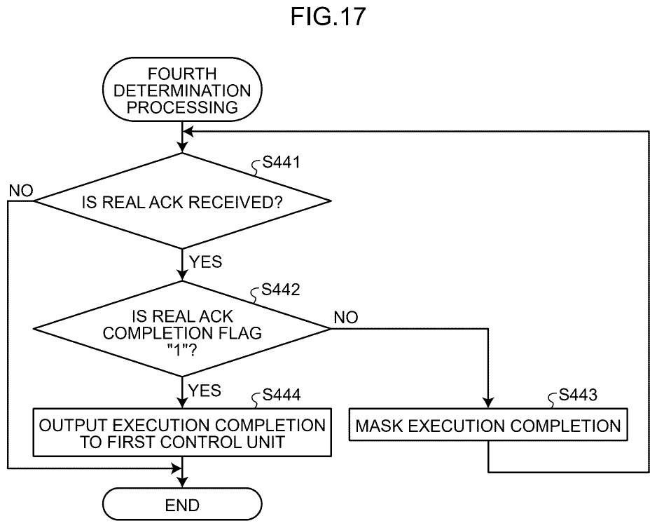

FIG. 17 is a flowchart illustrating an example of the processing operation related to the fourth determination processing in the first offload control unit 35A. In FIG. 17, the first offload control unit 35A determines whether a real ACK is received in step S52A or step S52B (step S441). If the real ACK is received (step S441: Yes), the first offload control unit 35A determines whether the completion flag of the received real ACK is “1” (step S442).

If the completion flag of the received real ACK is “1” (step S442: Yes), the first offload control unit 35A determines that the real ACK corresponds to the final processing request and outputs the completion of execution to the first control unit 14 (step S444). Then, the processing operation illustrated in FIG. 17 terminates.

If the completion flag of the received real ACK is not “1” (step S442: No), the first offload control unit 35A determines that the completion flag of the received real ACK is “0” and performs masking on the completion of execution to the first control unit 14 (step S443). Then, the first offload control unit 35A proceeds to step S441 to determine whether the next real ACK is received.

Further, the first offload control unit 35A, if no real ACK is received (step S441: No), terminates the processing operation illustrated in FIG. 17.

In the fourth determination processing, if the completion flag of the real ACK is “1”, it is determined that the real ACK corresponds to the final processing request and the completion of execution is notified to the first control unit 14. In the fourth determination processing, if the completion flag of the real ACK is “0”, it is determined that the real ACK does not correspond to the final processing request, and the completion of execution to the first control unit 14 is masked. As a result, it is possible for the first offload control unit 35A to determine whether the real ACK corresponds to the final processing request based on the completion flag, without counting the number of received real ACKs.

In the optical transmission system 1A according to the second embodiment, it is possible to avoid a situation in which the execution completion notification is erroneously sent to the first control unit 14 despite the fact that the processing request has not actually written data to the NVM 24 in the high-bandwidth SSD 22. As a result, the instruction source CPU 10 is capable of ensuring the access order upon reading the data after the write-processing operation to the NVM 24 during data roll-up.

The first offload control unit 35A notifies the first control unit 14 in the instruction destination CPU 11 of the completion of execution for the command in the case where a real ACK corresponding to the final processing request among multiple processing requests in the command is received. As a result, the instruction destination CPU 11 recognizes that all processing requests in the command are completed. Then, upon detecting the completion of execution, the instruction destination CPU 11 notifies the instruction source CPU 10 of the completion of the distributed processing. Accordingly, the instruction source CPU 10 determines that the distributed processing is complete upon detecting the completion of distributed processing from all of the instruction destination CPUs 11, thereby ensuring the access order during data roll-up.

The first offload control unit 35A performs masking on the completion of execution for the command in the case where a real ACK corresponding to a processing request other than the final processing request is received. As a result, the instruction destination CPU 11 recognizes that all processing requests in the command are completed.

The first offload control unit 35A determines whether the received real ACK is the final real ACK based on the completion flag in the received real ACK. The first offload control unit 35A, if the received real ACK is the final real ACK, notifies the first control unit 14 of the completion of command execution, whereas if the received real ACK is not the final real ACK, the first offload control unit 35A performs masking on the completion of execution to the first control unit 14. As a result, the instruction destination CPU 11 recognizes that all processing requests in the command are completed.

The first offload control unit 35A determines whether the processing request in the command is the final processing request, and if the processing request is not the final processing request, notifies the first queue 15 of a preliminary ACK for the processing request. As a result, until the final processing request is output, queue release of the first queue 15 can be accelerated, thereby improving throughput in the event of congestion in long-distance communication.

If the processing request in the command is the final processing request, the first offload control unit 35A performs masking on the preliminary ACK for the processing request to the first queue 15. As a result, masking the preliminary ACK to the first queue 15 makes it possible to prevent a situation in which the access order during data roll-up is reversed.

Upon detecting the issuance of a processing request, the instruction destination CPU 11 queues the processing request in the first queue 15. After requesting the notification of the processing request to the second offload control unit 35B, and before executing the processing request in the high-bandwidth SSD 22, the instruction destination CPU 11 queues the preliminary ACK for the processing request in the first queue 15 and releases the queue for the preliminary ACK for the processing request. As a result, until the final processing request is output, queue release of the first queue 15 can be accelerated, thereby improving throughput.

The optical transmission system 1A has the multiple instruction destination CPUs 11 and the instruction source CPU 10, which is connected in parallel to the multiple instruction destination CPUs 11 and is configured to transmit higher-level commands, such as distributed processing instructions, to each of the instruction destination CPUs 11 in parallel. Each of the instruction destination CPUs 11, Upon receiving a higher-level command, issues a command and transmits the command to the high-bandwidth SSD 22. The instruction source CPU 10, upon receiving the completion of execution from all of the instruction destination CPUs 11, determines that the distributed processing is complete. Accordingly, the instruction source CPU 10 determines that the distributed processing is complete upon detecting the completion of distributed processing from all of the instruction destination CPUs 11, thereby ensuring the access order during data roll-up.

Moreover, the optical transmission system 1 or 1A according to the first or second embodiment illustrates the case where the instruction source CPU 10 issues parallel instructions to each of the instruction destination CPUs 11 to perform distributed processing. However, a pipeline-based instruction of distributed processing to each of the instruction destination CPUs 11 may also be employed, and an embodiment related to this approach is described below as a third embodiment. Moreover, components identical to those in the optical transmission system 1 according to the first embodiment are denoted with the same reference numerals, and repeated descriptions of those components and operations are omitted.

### (f) Third Embodiment

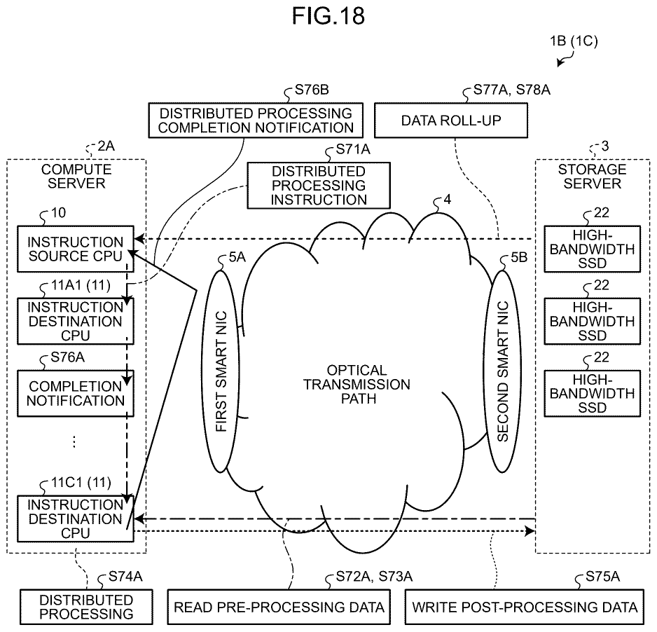

FIG. 18 is a diagram illustrated to describe an example of the processing operation related to pipeline-based distributed processing in an optical transmission system 1B according to a third embodiment. The instruction destination CPUs 11 of the compute server 2A include multiple CPUs, e.g., three CPUs 11A1, 11B1, and 11C1. In the pipeline-based distributed processing, the distributed processing is sequentially executed in the order of the instruction destination CPU 11A1, the instruction destination CPU 11B1, and then the instruction destination CPU 11C1. Moreover, the instruction destination CPU 11A1 is the first instruction destination CPU 11, and the instruction destination CPU 11C1 is the final instruction destination CPU 11.

The instruction source CPU 10 requests a distributed processing instruction to the first instruction destination CPU 11A1 (step S71A). The instruction destination CPU 11A1, in response to the distributed processing instruction, issues a read request to the high-bandwidth SSD 22 to read pre-distributed processing data from the high-bandwidth SSD 22 in the storage server 3 (step S72A). Then, the high-bandwidth SSD 22 reads the pre-distributed processing data in response to the read request from the instruction destination CPU 11A1 and transmits the read pre-distributed processing data to the instruction destination CPU 11A1 (step S73A).

The instruction destination CPU 11A1 executes distributed processing on the read pre-distributed processing data (step S74A). The instruction destination CPU 11A1 executes a write-processing operation to write the post-distributed processing data to the high-bandwidth SSD 22 (step S75A). Moreover, for convenience of description, one write-processing operation is assumed to be performed by dividing the post-distributed processing data into three segments and issuing three processing requests, each corresponding to one of the divided segments, to write to the NVM 24. In other words, each of the instruction destination CPUs 11 configures a single write-processing operation command with three processing requests and implements one write-processing operation with three processing requests. The instruction destination CPU 11A1, upon completion of the write-processing operation, notifies the next instruction destination CPU 11B1 of the completion of the distributed processing (step S76A).

Next, the next instruction destination CPU 11B1, in response to the completion of the distributed processing, issues a read request to the high-bandwidth SSD 22 to read the pre-distributed processing data from the high-bandwidth SSD 22 in the storage server 3 (step S72A). Then, the high-bandwidth SSD 22 reads the pre-distributed processing data in response to the read request from the instruction destination CPU 11B1 and transmits the read pre-distributed processing data to the instruction destination CPU 11B1 (step S73A).

The instruction destination CPU 11B1 executes distributed processing on the read pre-distributed processing data (step S74A). The instruction destination CPU 11B1 executes a write-processing operation to write the post-distributed processing data to the high-bandwidth SSD 22 (step S75A). The instruction destination CPU 11B1, upon completion of the write-processing operation, notifies the next instruction destination CPU 11C1 of the completion of the processing (step S76A). Moreover, for convenience of description, the instruction destination CPU 11C1 is assumed to be the final instruction destination CPU 11.

Subsequently, the final instruction destination CPU 11C1, in response to the completion of the distributed processing, issues a read request to the high-bandwidth SSD 22 to read the pre-distributed processing data from the high-bandwidth SSD 22 in the storage server 3 (step S72A). Then, the high-bandwidth SSD 22, in response to the read request from the instruction destination CPU 11C1, reads the pre-distributed processing data and transmits the read pre-distributed processing data to the instruction destination CPU 11C1 (step S73A).

The instruction destination CPU 11C1 executes the distributed processing on the read pre-distributed processing data (step S74A). The instruction destination CPU 11C1 executes the write-processing operation to write the post-distributed processing data to the high-bandwidth SSD 22 (step S75A). The instruction destination CPU 11C1, upon completion of the write-processing operation, notifies the next instruction source CPU 10 of the completion of distributed processing (step S76B).

The instruction source CPU 10, upon receiving a distributed processing completion notification from the final instruction destination CPU 11C1, determines that the post-write processing data from all of the instruction destination CPUs 11 has been written to the high-bandwidth SSD 22 and that distributed processing by all of the instruction destination CPUs 11 has been completed.

Then, the instruction source CPU 10 issues a data roll-up request to the high-bandwidth SSD 22 to read the post-write processing data written to the high-bandwidth SSD 22 (step S77A). The high-bandwidth SSD 22 reads the post-write processing data in response to the data roll-up request and transmits the read post-write processing data to the instruction source CPU 10 as the data roll-up result (step S78A).

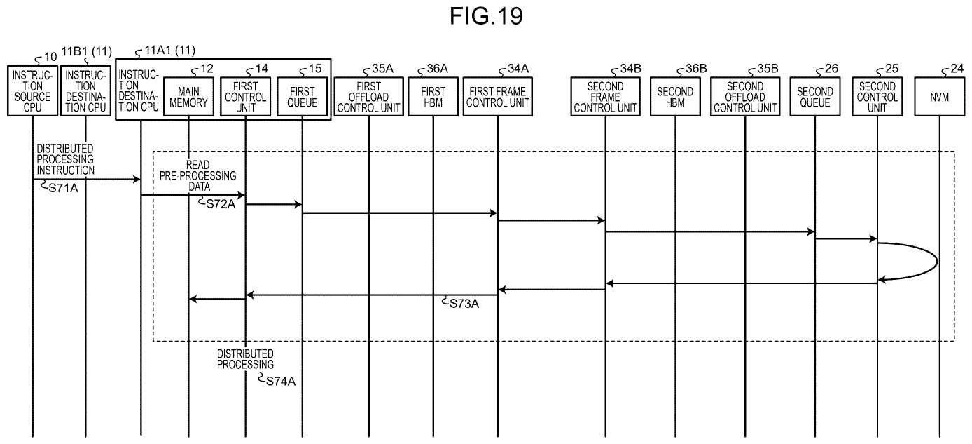

FIG. 19 is a sequence diagram illustrating an example of the processing operation related to pre-processing in the optical transmission system 1B according to the third embodiment. In FIG. 19, the instruction source CPU 10 requests a distributed processing instruction to the instruction destination CPU 11A1 (step S71A). The instruction destination CPU 11A1, in response to the distributed processing instruction, issues a read request to the high-bandwidth SSD 22 to read pre-distributed processing data from the high-bandwidth SSD 22 in the storage server 3 (step S72A). The first control unit 14 in the instruction destination CPU 11A1 transmits the read request to the first frame control unit 34A in the first smart NIC 5A using the first queue 15. The first frame control unit 34A in the first smart NIC 5A transmits the read request to the second frame control unit 34B in the second smart NIC 5B through the optical transmission path 4. Then, the second frame control unit 34B in the second smart NIC 5B transmits the read request to the second queue 26 in the high-bandwidth SSD 22.

Then, the high-bandwidth SSD 22 reads the pre-distributed processing data in response to the read request from the instruction destination CPU 11A1 and transmits the read pre-distributed processing data to the instruction destination CPU 11A1 (step S73A). Specifically, the second control unit 25 in the high-bandwidth SSD 22 reads the pre-distributed processing data from the NVM 24 in response to the read request from the second queue 26. The second control unit 25 transmits the pre-distributed processing data read from the NVM 24 to the second frame control unit 34B in the second smart NIC 5B. The second frame control unit 34B in the second smart NIC 5B transmits the pre-distributed processing data to the first frame control unit 34A in the first smart NIC 5A through the optical transmission path 4. The first frame control unit 34A in the first smart NIC 5A transmits the pre-distributed processing data to the first control unit 14 in the instruction destination CPU 11A1. The first control unit 14 stores the data received from the first frame control unit 34A in the main memory 12.

The instruction destination CPU 11A1 executes distributed processing on the read pre-distributed processing data (step S74A). The instruction destination CPU 11A1 executes the write-processing operation to write the post-distributed processing data to the high-bandwidth SSD 22.

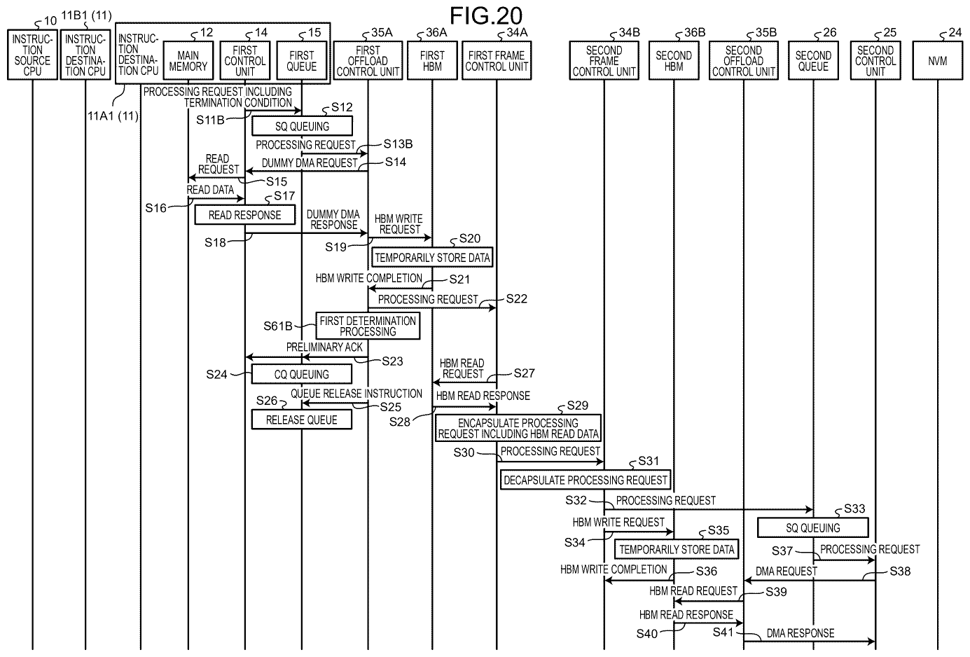

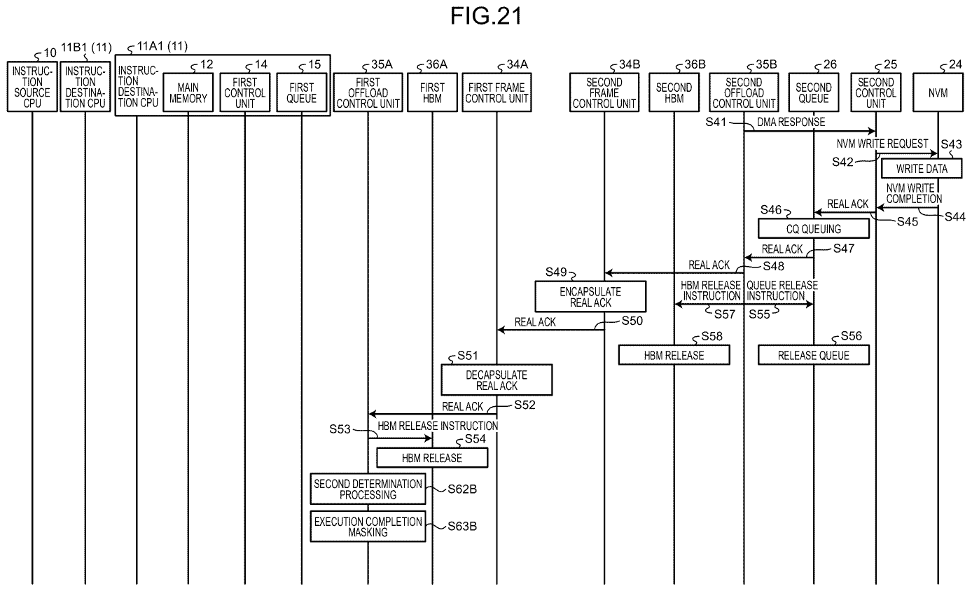

FIGS. 20 and 21 are sequence diagrams illustrating an example of the processing operation related to the third write-processing operation in the optical transmission system 1B according to the third embodiment. The first control unit 14 in the instruction destination CPU 11A1 issues a processing request under the NVMe-oF protocol, for example, a processing request to write the write-target data that is stored in the main memory 12 to the NVM 24. Moreover, for convenience of description, one write-processing operation is assumed to be implemented by three processing requests. In addition, the processing request includes a termination condition. The termination condition is assumed to include a first threshold used in a first determination processing operation of the first offload control unit 35A and a second threshold used in a second determination processing operation of the second offload control unit 35B, among other parameters.

The first control unit 14 issues a first processing request in response to the command to execute the third write-processing operation. Then, the first control unit 14 notifies the first queue 15 of the issued processing request, i.e., the first processing request (step S11B). The first SQ 15A in the first queue 15 proceeds to step S12, in which the first SQ 15A performs SQ queuing for the notified processing request.

The first offload control unit 35A in the first smart NIC 5A detects the processing request that includes a termination condition currently queued in the first SQ 15A in accordance with the doorbell function of the first queue 15 (step S13B). The first offload control unit 35A sets, among the termination conditions in the detected processing request, the first threshold to be used in the first determination processing and the second threshold to be used in the second determination processing. Moreover, the first threshold is used to determine whether to perform masking on a preliminary ACK, i.e., the number of processing requests in the command for executing one third write-processing operation. The second threshold is used to determine whether to perform masking on the completion of execution, i.e., corresponds to the number of processing requests in the command. For example, if the number of processing requests included in the command is “3”, both the first and second thresholds are set to “3”. The first offload control unit 35A proceeds to step S14, in which it notifies the first control unit 14 of a dummy DMA request in response to the detected processing request.

Further, the first offload control unit 35A, after detecting the completion of the HBM write in step S21, proceeds to step S22, in which the first offload control unit 35A notifies the first frame control unit 34A of the processing request detected in step S13B. The first offload control unit 35A, after notifying the first frame control unit 34A of the processing request in step S22, executes first determination processing (step S61B). The first determination processing is a processing operation for determining whether to perform masking on a preliminary ACK to the first queue 15. If it is determined that the processing request is not the final among the multiple processing requests in the command, the first determination processing transfers the preliminary ACK to the first control unit 14 and the first queue 15 (step S23C). The first determination processing is the processing operation illustrated in FIG. 10.

In FIG. 21, the first offload control unit 35A requests an HBM release instruction from the first HBM 36A in response to the real ACK in step S53, and then executes the second determination processing (step S62B). The second determination processing is a processing operation for determining whether a real ACK for the final processing request is received. The second determination processing corresponds to the processing operation illustrated in FIG. 11.

The first offload control unit 35A, if no real ACK for the final processing request is received in the second determination processing of step S62B, determines that the real ACK corresponds to a processing request other than the final processing request. Then, the first offload control unit 35A performs masking on the completion of execution to the first queue 15 and the first control unit 14 (step S63B) and proceeds to continue the processing of step S11B. As a result, the first control unit 14 does not receive the completion of execution from the first offload control unit 35A, thereby avoiding notification of the distributed processing completion to the instruction source CPU 10.

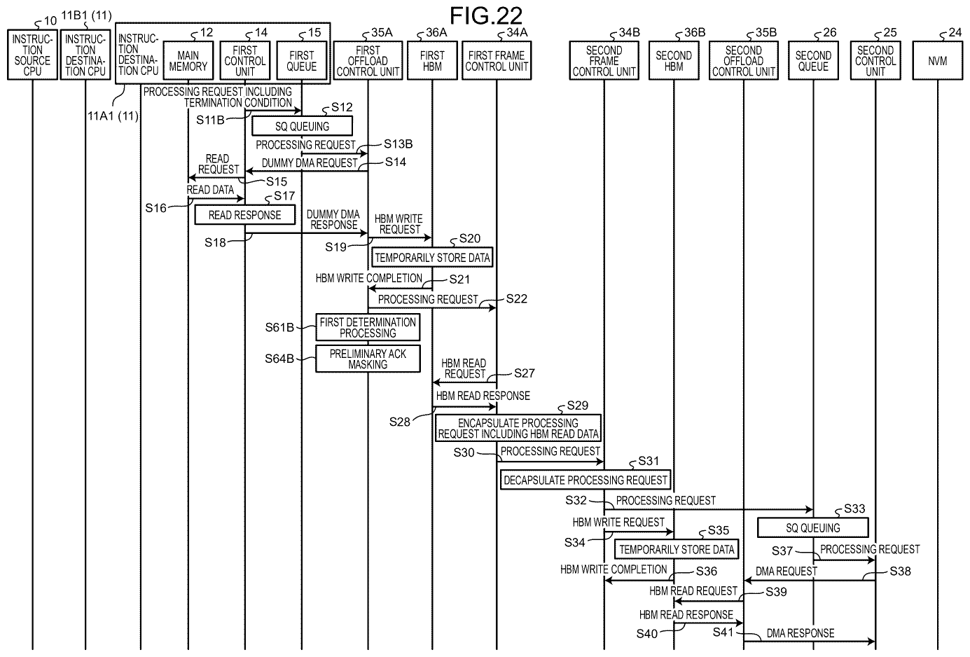

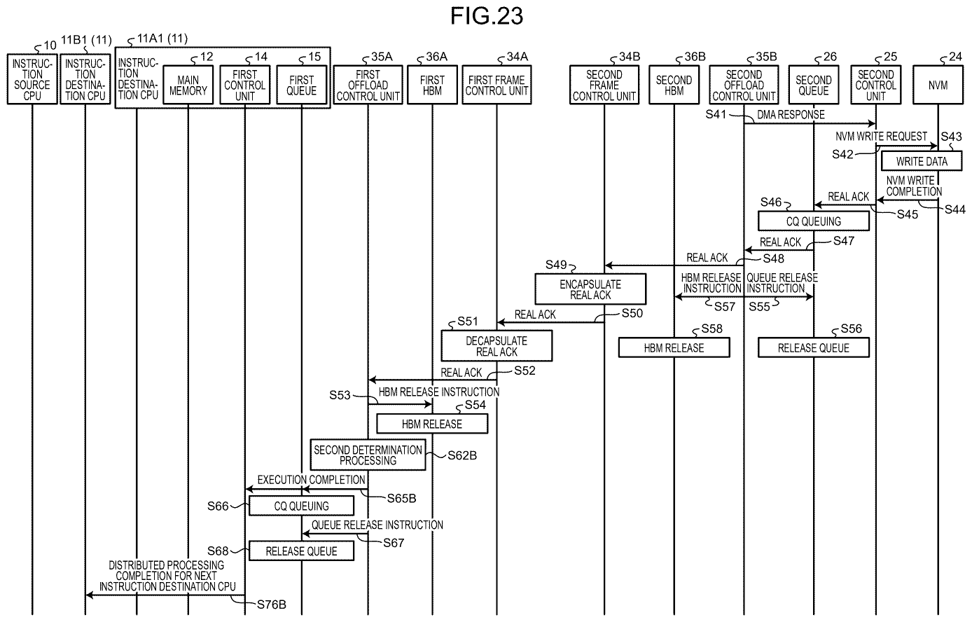

FIGS. 22 and 23 are sequence diagrams illustrating an example of the processing operation related to the third write-processing operation in the optical transmission system 1B according to the third embodiment. In FIG. 22, the first offload control unit 35A notifies the first frame control unit 34A of a processing request in step S22, and then executes the first determination processing in step S61B.

If the first offload control unit 35A determines that the processing request is the final processing request, the first offload control unit 35A performs masking on the preliminary ACK to the first queue 15 (step S64B). If the first determination processing determines that the processing request is the final processing request among the multiple processing requests in the command, it performs masking on the preliminary ACK for the final processing request to the first control unit 14 and the first queue 15. As a result, masking the preliminary ACK to the first queue 15 prevents the queue of the first queue 15 from being released.

Further, in FIG. 23, the first offload control unit 35A, upon determining in the second determination processing of step S62B that the real ACK corresponds to the final processing request, proceeds to step S65B and notifies the first queue 15 and the first control unit 14 of the completion of execution. The first CQ 15B in the first queue 15 proceeds to step S66 in which it performs CQ queuing for the notified execution completion. In addition, the first offload control unit 35A, after notifying the first queue 15 of the completion of execution, proceeds to step S67 in which it notifies the first queue 15 of the queue release instruction.

The first queue 15, in response to the queue release instruction, proceeds to step S68 in which it releases the information regarding the target SQ/CQ pair. In other words, the first offload control unit 35A determines that all processing requests including the write-target data in the second smart NIC 5B are completed, and releases the queue of the first queue 15.

Then, the first control unit 14, upon detecting the completion of execution in step S65B, determines that all processing requests in the command for the third write-processing operation are executed, and notifies the next instruction destination CPU 11B1 of the completion of distributed processing (step S76B). In other words, the first control unit 14, upon detecting the completion of execution for the third processing request, determines that all three processing requests in the command for the third write-processing operation are executed, and notifies the next instruction destination CPU 11B1 of the completion of distributed processing. As a result, it is possible for the next instruction destination CPU 11B1 to recognize the completion of the third write-processing operation in the preceding instruction destination CPU 11A1.

Then, in response to the distributed processing completion notification from the instruction destination CPU 11A1, the next instruction destination CPU 11B1 executes the pre-distributed processing of steps S72A and S73A and the distributed processing of step S74A, and then executes the third write-processing operation illustrated in FIGS. 20 to 23. After executing the third write-processing operation, the instruction destination CPU 11B1 notifies the final instruction destination CPU 11C1 of the completion of distributed processing.

Further, in response to the completion of distributed processing from the instruction destination CPU 11B1, the instruction destination CPU 11C1 executes the pre-distributed processing of steps S72A and S73A and the distributed processing of step S74A, and then executes the third write-processing operation illustrated in FIGS. 20 to 23. After executing the third write-processing operation, the final instruction destination CPU 11C1 notifies the instruction source CPU 10 of the completion of distributed processing.

In other words, in the optical transmission system 1B, from SQ queuing to the release of the information regarding the SQ/CQ pair, a single handshake per processing request in step S30 between the compute server 2A and the storage server 3 is sufficient. This makes it possible to shorten the transmission latency related to each processing request. Specifically, without increasing the number of CPU cores, it is possible to implement the optical transmission system 1 for NVMe-oF that is suitable for long-distance transmission and capable of improving processing delay including transmission latency.

The instruction source CPU 10, upon detecting the completion of distributed processing by the final instruction destination CPU 11C1, recognizes the completion of distributed processing by all of the instruction destination CPUs 11, and is capable of executing the data roll-up processing of steps S77A and S78A.

In the optical transmission system 1B according to the third embodiment, even in the case where pipeline-based distributed processing is employed, it is possible to avoid a situation in which the completion of execution is erroneously notified to the first control unit 14 despite the fact that the data has not actually been written into the NVM 24 of the high-bandwidth SSD 22 due to a processing request. As a result, the instruction source CPU 10 is capable of ensuring the access order upon reading the data after the write-processing operation to the NVM 24 during data roll-up.

The first offload control unit 35A notifies the first control unit 14 in the instruction destination CPU 11 of the completion of execution for the command in the case where a real ACK corresponding to the final processing request among multiple processing requests in the command is received. As a result, the instruction destination CPU 11 recognizes that all processing requests in the command are completed. Then, the instruction destination CPU 11, upon detecting the completion of execution, notifies the next instruction destination CPU 11 of the completion of distributed processing. As a result, the instruction source CPU 10, upon detecting the completion of distributed processing from the final instruction destination CPU 11C1, determines that the distributed processing by all of the instruction destination CPUs 11 is complete, ensuring the correct access order during data roll-up.

The optical transmission system 1B includes the multiple instruction destination CPUs 11 and the instruction source CPU 10, which is connected in series with the multiple instruction destination CPUs 11 and transmits the higher-level command to the first instruction destination CPU 11A1 among the instruction destination CPUs 11. The first instruction destination CPU 11A1, upon receiving the higher-level command, issues a command and, upon receiving a real ACK for the final processing request in the command, transmits the completion of execution to the subsequent-stage instruction destination CPU 11B1 connected in the series. The subsequent-stage instruction destination CPU 11B1, upon receiving the completion of execution from the preceding-stage instruction destination CPU 11A1 connected in series, issues a command. Furthermore, the instruction destination CPU 11B1, upon receiving a real ACK for the final processing request in the command, transmits the completion of execution to the subsequent-stage instruction destination CPU 11C1 in the series. The final instruction destination CPU 11C1 in the series, upon receiving the completion of execution from the preceding-stage instruction destination CPU 11B1 in the series, issues a command and, upon receiving a real ACK for the final processing request in the command, transmits the completion of execution to the instruction source CPU 10. The instruction source CPU 10, upon receiving the completion of execution from the final instruction destination CPU 11C1, determines that execution of the higher-level command is complete. As a result, the instruction source CPU 10, upon detecting the completion of distributed processing from the final instruction destination CPU 11C1, determines that the distributed processing by all of the instruction destination CPUs 11 is complete, ensuring the correct access order during data roll-up.

In the optical transmission system 1B according to the third embodiment, the case is illustrated in which the second determination processing determines whether to perform masking on the completion of execution to the first control unit 14 based on the second counter value indicating the number of received real ACKs from the second offload control unit 35B. However, embodiments of the present disclosure are not limited to the exemplary embodiment herein and can be modified as appropriate. Thus, another embodiment is described below as a fourth embodiment. Moreover, components identical to those in the optical transmission system 1B according to the third embodiment are denoted with the same reference numerals, and repeated descriptions of those components and operations are omitted.

### (g) Fourth Embodiment

The second offload control unit 35B, upon transmitting a real ACK to the first smart NIC 5A, stores, in the real ACK, a completion flag that identifies whether the real ACK corresponds to the final processing request in the fourth write-processing operation. If the real ACK corresponds to the final processing request in the fourth write-processing operation, the second offload control unit 35B stores the completion flag of “1” in the real ACK. If the real ACK does not correspond to the final processing request in the fourth write-processing operation, the second offload control unit 35B stores the completion flag of “0” in the real ACK.

The first offload control unit 35A, upon receiving a real ACK, determines whether to perform masking on the completion of execution to the first control unit 14 based on the presence or absence of the completion flag in the real ACK. If the completion flag in the real ACK is “1”, the first offload control unit 35A notifies the first control unit 14 of the completion of execution. If the completion flag in the real ACK is “0”, the first offload control unit 35A performs masking on the completion of execution to the first control unit 14.

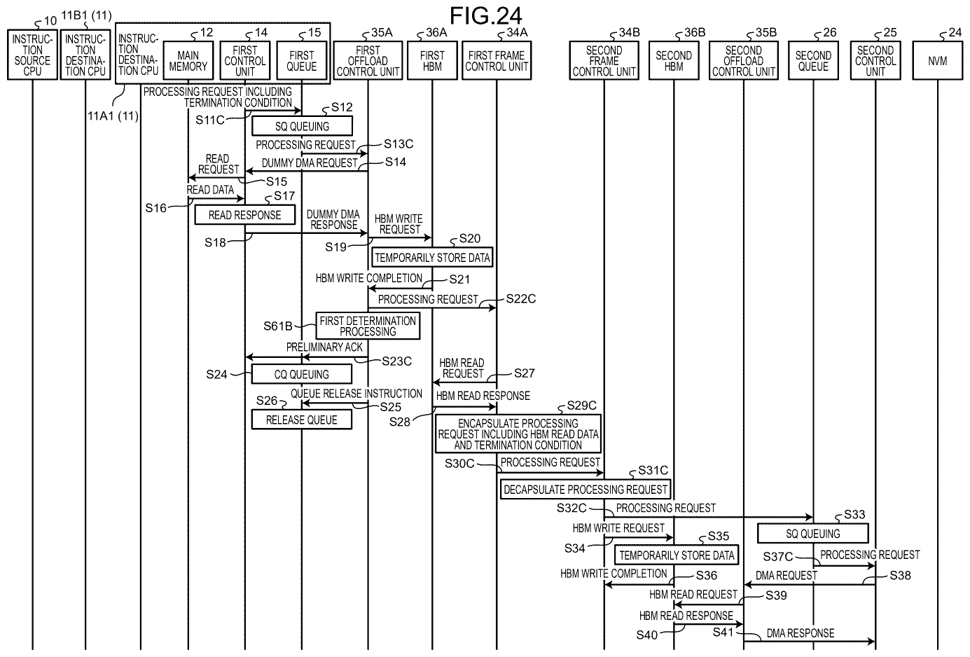

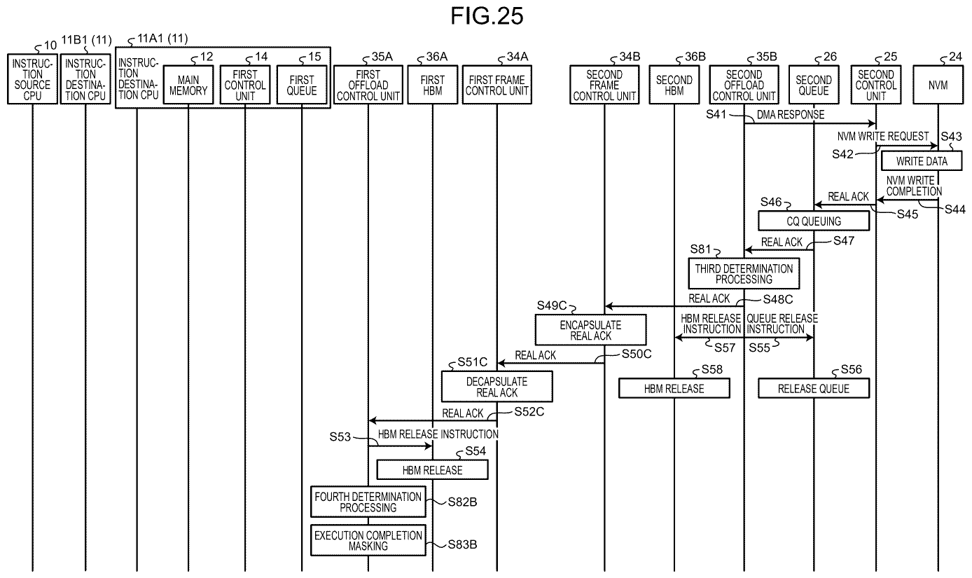

FIGS. 24 and 25 are sequence diagrams illustrating an example of the processing operation related to the fourth write-processing operation in an optical transmission system 1C according to a fourth embodiment. Moreover, for convenience of description, it is assumed that one instance of the fourth write-processing operation is implemented using, for example, three processing requests. The first control unit 14 issues the first processing request in response to a command for executing the fourth write-processing operation. The first control unit 14 in the instruction destination CPU 11A1 notifies the first queue of the processing request including the termination condition, i.e., the first processing request (step S11C). The termination condition includes a first threshold used in the first determination processing, a third threshold and completion flag setting used in the third determination processing, and a determination criterion for the completion flag used in the fourth determination processing.

The first offload control unit 35A in the first smart NIC 5A detects the processing request including the termination condition currently queued in the first SQ 15A in accordance with the doorbell function of the first queue 15 (step S13C) and proceeds to the processing of step S14. The first offload control unit 35A sets the first threshold to be used in the first determination processing and the determination criterion to be used in the fourth determination processing, among the termination conditions in the detected processing request. Moreover, the determination criterion is a parameter for determining whether to perform masking on the completion of execution, as described below.

Further, the first offload control unit 35A, after detecting the completion of the HBM write in step S21, notifies the first frame control unit 34A of the processing request including the termination condition detected in step S13C (step S22C).

Further, the first frame control unit 34A, upon detecting the HBM read response in step S28, encapsulates the processing request including the HBM read data and the termination condition (step S29C). The first frame control unit 34A optically converts the encapsulated processing request via the first optical transceiver 31A and optically transmits the optically converted processing request to the second smart NIC 5B through the optical transmission path 4 (step S30C). In other words, the first offload control unit 35A reads the write-target data that is temporarily stored in the first HBM 36A and optically transmits the processing request including the write-target data that is read and the termination condition to the second smart NIC 5B as the first handshake.

Further, the first offload control unit 35A, after notifying the first frame control unit 34A of the processing request in step S22C, executes the first determination processing in step S61B.

Further, the second frame control unit 34B in the second smart NIC 5B electrically converts the encapsulated processing request including the termination condition via the second optical transceiver 31B. The second frame control unit 34B decapsulates the electrically converted processing request and separates it into the processing request including the termination condition and the write-target data (step S31C). The second frame control unit 34B notifies the second queue 26 in the controller 23 of the separated processing request (step S32C) and proceeds to the processing of step S33.

Further, the second control unit 25 detects the processing requests queued in the second SQ 26A in accordance with the doorbell function of the second queue 26 (step S37C). Moreover, the second offload control unit 35B, upon detecting the processing request, also sets a third threshold and a completion flag setting criterion to be used in the third determination processing among the termination conditions in the detected processing request. The third threshold is a threshold for determining whether a real ACK corresponds to the final processing request, i.e., it corresponds to the number of all processing requests in the command for executing one instance of the fourth write-processing operation. For example, if the total number of processing requests in the command is “3”, the third threshold is “3”. The setting criterion is a criterion for storing a completion flag of “1” or “0” in the real ACK.

In FIG. 25, the second offload control unit 35B executes the third determination processing in response to a real ACK from the second queue 26 in step S47 (step S81). In the third determination processing, it is determined whether the real ACK corresponds to the final processing request among the multiple processing requests in the command. Then, in the third determination processing, if the real ACK corresponds to the final processing request, the real ACK including a completion flag of “1” is output, and if the real ACK does not correspond to the final processing request, the real ACK including a completion flag of “0” is output.

If it is determined in step S81 that the real ACK does not correspond to the final processing request, the second offload control unit notifies the second frame control unit 34B of the real ACK including the completion flag of “0” (step S48C).

The second frame control unit 34B, upon detecting the real ACK from the second offload control unit 35B, encapsulates the real ACK including the completion flag of “0” (step S49C). The second frame control unit 34B optically converts the encapsulated real ACK via the second optical transceiver 31B and optically transmits the optically converted real ACK to the first smart NIC 5A through the optical transmission path 4 (step S50C). Moreover, the real ACK including the completion flag in step S50C is the second handshake. However, since the information regarding the SQ/CQ pair targeted by the first queue 15 has already been released in step S26, this does not affect the throughput on the side of the instruction destination CPU 11A1.

The first frame control unit 34A in the first smart NIC 5A electrically converts the encapsulated real ACK via the first optical transceiver 31A and decapsulates the electrically converted real ACK (step S51C). Furthermore, the first frame control unit 34A notifies the first offload control unit 35A of the decapsulated real ACK (step S52C).

The first offload control unit 35A, in response to the real ACK in step S53, requests the first HBM 36A to issue an HBM release instruction. Then, in step S54, the first HBM 36A executes HBM release by erasing the write-target data in response to the HBM release instruction. As a result, the first HBM 36A is capable of erasing the write-target data in response to the HBM release instruction.

The first offload control unit 35A executes the fourth determination processing (step S82B). In the fourth determination processing, the completion flag in the real ACK is identified, and if the identified completion flag is “0”, the completion of execution is masked to the first control unit 14, whereas if the identified completion flag is “1”, the completion of execution is notified to the first control unit 14. If the completion flag in the real ACK is “0” in step S82, the first offload control unit 35A performs masking on the completion of execution to the first control unit 14 (step S83B) and proceeds to the processing of step S11C. As a result, the first control unit 14 does not receive the execution completion notification from the first offload control unit 35A, and so it is possible to avoid notifying the next instruction destination CPU 11B1 of the completion of distributed processing.

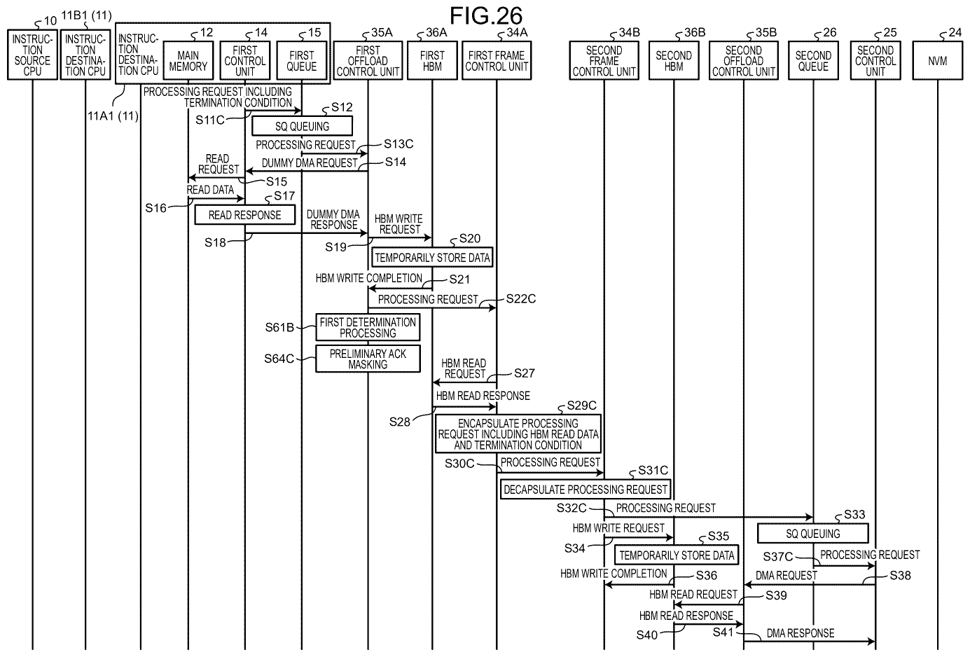

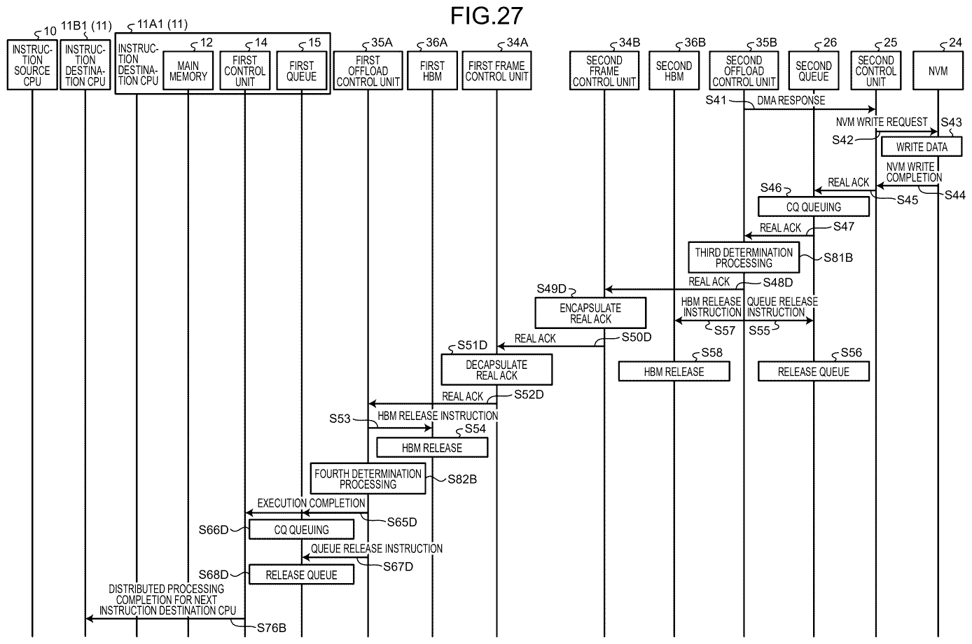

FIGS. 26 and 27 are sequence diagrams illustrating an example of the processing operation related to the fourth write-processing operation in the optical transmission system 1C according to the fourth embodiment. In FIG. 26, the first offload control unit 35A notifies the first frame control unit 34A of the processing request in step S22C, and then executes the first determination processing (step S61B). If it is determined in the first determination processing that the request is the final processing request, the first offload control unit 35A performs masking on the preliminary ACK to the first queue 15 (step S64C). As a result, masking the preliminary ACK to the first queue 15 avoids the preliminary ACK from being queued in the first queue 15.

In FIG. 27, the second offload control unit 35B executes the third determination processing in response to the real ACK from the second queue 26 in step S47 (step S81B). If it is determined in step S81B that the real ACK corresponds to the final processing request, the second offload control unit 35B notifies the second frame control unit 34B of the real ACK including the completion flag of “1” (step S48D).

The second frame control unit 34B, upon detecting the real ACK from the second offload control unit 35B, encapsulates the real ACK including the completion flag of “1” (step S49D). The second frame control unit 34B optically converts the encapsulated real ACK via the second optical transceiver 31B, and optically transmits the optically converted real ACK to the first smart NIC 5A through the optical transmission path 4 (step S50D). Moreover, the real ACK in step S50D is the second handshake. However, since the information regarding the SQ/CQ pair targeted by the first queue 15 has already been released in step S26, this does not affect the throughput on the side of the instruction destination CPU 11A1.

The first frame control unit 34A in the first smart NIC 5A electrically converts the encapsulated real ACK via the first optical transceiver 31A and decapsulates the electrically converted real ACK (step S51D). Furthermore, the first frame control unit 34A notifies the first offload control unit 35A of the decapsulated real ACK (step S52D). The first offload control unit 35A executes the fourth determination processing (step S82B).

If the completion flag in the real ACK is “1” in step S82, the first offload control unit 35A notifies the first queue 15 and the first control unit 14 of the completion of execution (step S65D). The first CQ 15B in the first queue 15 performs CQ queuing of the notified execution completion (step S66D). In addition, the first offload control unit 35A, after notifying the first queue 15 of the completion of execution, notifies the first queue 15 of the queue release instruction (step S67D).

The first queue 15 releases the information regarding the target SQ/CQ pair in response to the queue release instruction (step S68D). In other words, the first offload control unit 35A determines that all processing requests including the write-target data in the second smart NIC 5B are completed, and releases the queue of the first queue 15.

Then, the first control unit 14, upon detecting the completion of execution in step S65D, determines that all processing requests in the command for the fourth write-processing operation have been executed, and notifies the next instruction destination CPU 11B1 of the completion of distributed processing (step S76B). In other words, the first control unit 14, upon detecting the completion of execution of the third processing request, determines that the three processing requests in the command for the fourth write-processing operation have been executed, and notifies the next instruction destination CPU 11B1 of the completion of distributed processing. As a result, it is possible for the instruction destination CPU 11B1 to recognize the completion of the fourth write-processing operation in the instruction destination CPU 11A1.

Then, in response to the distributed processing completion notification from the instruction destination CPU 11A1, the instruction destination CPU 11B1 executes the pre-distributed processing of steps S72A and S73A, and the distributed processing of step S74A, and then executes the fourth write-processing operation illustrated in FIGS. 24 to 27. Then, after executing the fourth write-processing operation, the instruction destination CPU 11B1 notifies the instruction destination CPU 11C1 of the completion of distributed processing.

Furthermore, in response to the completion of distributed processing from the instruction destination CPU 11B1, the instruction destination CPU 11C1 executes the pre-distributed processing of steps S72A and S73A, and the distributed processing of step S74A, and then executes the fourth write-processing operation illustrated in FIGS. 24 to 27. Then, after executing the fourth write-processing operation, the instruction destination CPU 11C1 notifies the instruction source CPU 10 of the completion of distributed processing.

In other words, in the optical transmission system 1C, from SQ queuing to the release of the SQ/CQ pair information, only a single handshake of step S30C is sufficient for one processing request between the compute server 2 and the storage server 3. This makes it possible to shorten the transmission latency related to each processing request. Specifically, without increasing the number of CPU cores, it is possible to implement the optical transmission system 1 for NVMe-oF that is suitable for long-distance transmission and capable of improving processing delay including transmission latency.

The instruction source CPU 10, upon detecting the completion of distributed processing by the final instruction destination CPU 11C1, recognizes the completion of distributed processing by all of the instruction destination CPUs 11, and is capable of executing the data roll-up processing of steps S77A and S78A.

In the optical transmission system 1C according to the fourth embodiment, even in the case where pipeline-based distributed processing is employed, it is possible to avoid a situation in which the first control unit 14 is erroneously notified of the completion of execution despite the fact that the processing request has not actually been written to the NVM 24 in the high-bandwidth SSD 22. As a result, the instruction source CPU 10 is capable of ensuring the access order upon reading the data after the write-processing operation to the NVM 24 during data roll-up.

The first offload control unit 35A notifies the first control unit 14 in the instruction destination CPU 11 of the completion of execution for the command in the case where a real ACK corresponding to the final processing request among multiple processing requests in the command is received. As a result, the instruction destination CPU 11 recognizes that all processing requests in the command are completed. Then, the final instruction destination CPU 11, upon detecting the completion of execution, notifies the instruction source CPU 10 of the completion of distributed processing. As a result, the instruction source CPU 10, upon detecting the completion of distributed processing from the final instruction destination CPU 11C1, determines that the distributed processing by all of the instruction destination CPUs 11 is complete, ensuring the correct access order during data roll-up.

The optical transmission system 1C includes the multiple instruction destination CPUs 11 and the instruction source CPU 10 that is connected in series with the multiple instruction destination CPUs 11 and is configured to transmit a higher-level command to the first instruction destination CPU 11A1 among the multiple serially connected instruction destination CPUs 11. The first instruction destination CPU 11A1, upon receiving the higher-level command, issues a command and, upon receiving a real ACK for the final processing request in the command, transmits the completion of execution to the subsequent-stage instruction destination CPU 11B1 connected in the series. The subsequent-stage instruction destination CPU 11B1, upon receiving the completion of execution from the preceding-stage instruction destination CPU 11A1 connected in series, issues a command. Furthermore, the instruction destination CPU 11B1, upon receiving a real ACK for the final processing request in the command, transmits the completion of execution to the subsequent-stage instruction destination CPU 11C1 in the series. The final instruction destination CPU 11C1 in the series, upon receiving the completion of execution from the preceding-stage instruction destination CPU 11B1 in the series, issues a command and, upon receiving a real ACK for the final processing request in the command, transmits the completion of execution to the instruction source CPU 10. The instruction source CPU 10, upon receiving the completion of execution from the final instruction destination CPU 11C1, determines that execution of the higher-level command is complete. As a result, the instruction source CPU 10, upon detecting the completion of distributed processing from the final instruction destination CPU 11C1, determines that the distributed processing by all of the instruction destination CPUs 11 is complete, ensuring the correct access order during data roll-up.

In the NVMe-oF optical transmission system 100 according to the first comparative example using a single-core CPU for long-distance applications, the transmission distance between the compute server 110 and the storage server 120 is 1200 km, and the processing time per entry is 300 ns. Furthermore, in the optical transmission system 100, it is assumed that the amount of data processed per entry is 4 KB, the data processing throughput per entry is 109 Gbps, the processing time per entry until queue release is 30 ms, and the number of CPU cores is one. The throughput of the comparative example of the optical transmission system 100 is approximately 1 Gbps. In addition, the data retransmission function is also executed at the application layer.

In an NVMe-oF optical transmission system for long-distance applications using a multi-core CPU, the transmission distance between the compute server 110 and the storage server 120 is 1200 km, and the processing time per entry is 300 ns. Furthermore, in the optical transmission system described above, it is assumed that the amount of data processed per entry is 4 KB, the data processing throughput per entry is 109 Gbps, the processing time until queue release per entry is 30 ms, and the number of CPU cores is 30. In this case, the throughput is approximately 109 Gbps. In addition, the data retransmission function is also executed at the application layer.

In contrast, in the optical transmission system 1 according to the present embodiment, which employs a single-core CPU and is applicable to long-distance NVMe-oF, the transmission distance between the compute server 2 and the storage server 3 is 1200 km, and the processing time per entry is 300 ns. Furthermore, in the optical transmission system 1 (1A, 1B, or 1C), the amount of data processed per entry is 4 KB, the data processing throughput per entry is 109 Gbps, the processing time per entry until queue release is 6 ms, and the number of CPU cores is one. The throughput of the optical transmission systems 1 (1A, 1B, or 1C) according to the present embodiment is approximately 109 Gbps. Additionally, the data retransmission function is implemented in hardware.

This demonstrates that the optical transmission system 1 (1A, 1B, or 1C) according to the present embodiment significantly improves throughput, compared to the optical transmission system 100 according to the comparative example. Moreover, compared to the optical transmission systems that employ multi-core CPUs, it is possible to improve throughput while keeping component costs lower.

Moreover, while the present embodiment illustrates an example in which the instruction source CPU 10 and the multiple instruction destination CPUs 11 are arranged within the same compute server 2, this configuration is not limiting, and various modifications may be made as appropriate.

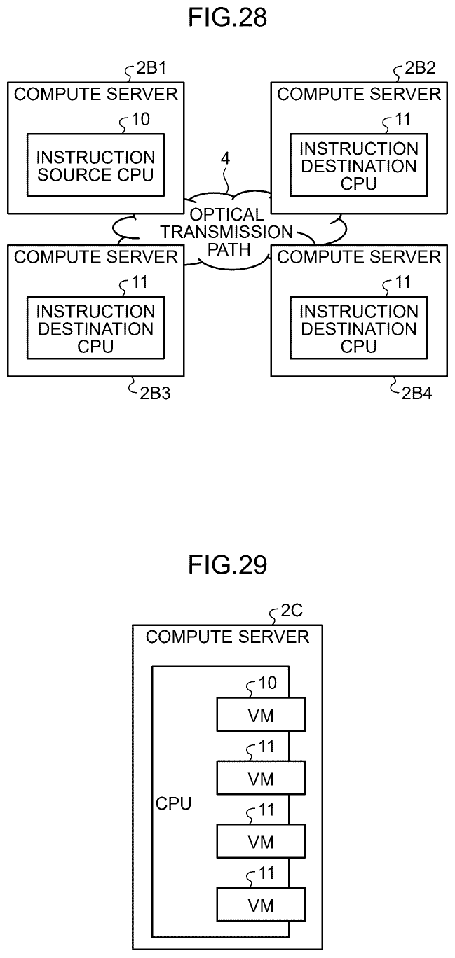

FIG. 28 is a diagram illustrated to describe an example of an instruction source CPU 10 and an instruction destination CPU 11 in another embodiment. In FIG. 28, multiple compute servers 2B1, 2B2, 2B3, and 2B4 are connected via an optical transmission path 4. The compute server 2B1 is arranged with the instruction source CPU 10. The compute server 2B2 is arranged with another instruction destination CPU 11. The compute server 2B3 is arranged with still another instruction destination CPU 11. The compute server 2B4 is provided with yet another instruction destination CPU 11. The CPUs of the respective compute servers 2 connected through the optical transmission path 4 can be used as the instruction source CPU 10 or the instruction destination CPU 11, and this configuration can be modified as appropriate.

FIG. 29 is a diagram illustrated to describe an example of an instruction source CPU 10 and an instruction destination CPU 11 in another embodiment. In FIG. 29, a single CPU is provided within a compute server 2C. The CPU deploys multiple virtual machines (VMs) in memory (not illustrated), with one of the multiple virtual machines may be the instruction source CPU 10 and three of the multiple virtual machines may be the instruction destination CPU 11, and this configuration can be modified as appropriate.

Moreover, for convenience of description, the first smart NIC 5A can be embedded in the compute server 2, and the second smart NIC 5B can be embedded in the storage server 3, however this configuration can be modified as appropriate.

While the example is provided in which the processing request is a request to write the write-target data stored in the main memory 12 to the NVM 24, this configuration is not limited to this example and can be modified as appropriate.

Although the example is described in which the optical transmission is performed using the optical transmission path 4 between the compute server 2 and the storage server 3, a possible configuration is not limited to the optical transmission path 4, and a transmission path for transmitting electrical signals can also be used, and this can be modified as appropriate.

Although the case is illustrated in which encapsulation and decapsulation are performed upon transmitting signals between the first smart NIC 5A and the second smart NIC 5B, this configuration is not limiting, and signal transmission may also be performed without encapsulation or decapsulation, and this can be modified as appropriate.

Although the case is illustrated in which the NVMe-oF protocol is used upon transmitting signals between the first smart NIC 5A and the second smart NIC 5B, this configuration is not limiting, and any communication protocol that manages a processing request using a queue can be employed, as appropriate.

The case is illustrated in which the instruction destination CPU 11 performs a write-processing operation to write data to the NVM 24 within a single high-bandwidth SSD 22 in the storage server 3. However, multiple high-bandwidth SSDs 22 can be arranged within the storage server 3, and the instruction destination CPU 11 can execute a write-processing operation in which data is written to multiple high-bandwidth SSDs 22, and also this can be modified as appropriate.

Furthermore, the individual components illustrated in the figures do not necessarily have to be physically configured as illustrated. In other words, the specific form of distribution or integration of each component is not limited to the illustrated configuration, and some or all of the components can be functionally or physically distributed and integrated in any unit depending on various loads, usage conditions, or other factors.

Furthermore, the various processing functions performed by each device can be executed in whole or in part by a central processing unit (CPU) (or a microcomputer such as a micro processing unit (MPU) or micro controller unit (MCU)). It goes without saying that the various processing functions can be executed in whole or in part by a program that is analyzed and executed by a CPU (or a microcomputer such as an MPU or MCU), or by hardware implemented using wired logic.

According to one aspect, the present disclosure provides a transmission system suitable for long-distance transmission between a control device and a processing device.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is

1. A transmission system comprising: a control device configured to issue a command including at least one processing request; a processing device configured to execute respective processing corresponding to each processing request in the command; and a transmission device configured to communicate between the control device and the processing device,
wherein the processing device is configured to,
upon executing the processing corresponding to the processing request among a plurality of processing requests in the command, notify the transmission device of completion of processing for the processing request, and
the transmission device is configured to,
upon receiving the completion of processing corresponding to a final processing request among the plurality of processing requests in the command, notify the control device of completion of execution for the command.

2. The transmission system according to claim 1, wherein the transmission device is further configured to, upon receiving the completion of processing corresponding to the processing request other than the final processing request, perform masking on the completion of execution for the command.

3. The transmission system according to claim 1, wherein the transmission device is further configured to count a number of times completion of processing corresponding to the processing request is received, determine whether the received count matches the number of processing requests in the command, and, when the received count matches the number of the processing requests, determine that the completion of processing for the final processing request is received.

4. The transmission system according to claim 1, wherein the processing device is further configured to, upon executing the processing corresponding to the processing request among the plurality of processing requests in the command and notifying the transmission device of the completion of processing corresponding to the processing request, notify the transmission device of the completion of processing including an identifier indicating that the processing request is the final processing request when the processing request is the final processing request, and notify the transmission device of the completion of processing including the identifier indicating that the processing request is not the final processing request when the processing request is not the final processing request, and
the transmission device is further configured to,
upon receiving the completion of processing from the processing device, determine whether the completion of processing is the final completion of processing based on the identifier indicating the completion of processing, notify the control device of the completion of execution for the command when the received completion of processing is the final completion of processing, and perform masking on the completion of execution to the control device when the received completion of processing is not the final completion of processing.

5. The transmission system according to claim 1, wherein
the transmission device is further configured to,
upon notifying the processing device of the processing request in the command, determine whether the notified processing request is the final processing request,
the transmission device is further configured to, when the notified processing request is not the final processing request, notify the control device of preliminary completion of the processing request, and
the transmission device is further configured to, when the notified processing request is the final processing request, perform masking on the preliminary completion of the processing request to the control device, request the control device to notify the processing device of the processing request, and, prior to execution of the processing request by the processing device, queue the preliminary completion of the processing request in a queue and then release the queue of the preliminary completion of the processing request.

6. The transmission system according to claim 1, wherein
the transmission device is further configured to,
upon notifying the processing device of the processing request in the command and upon not distributing the notified processing request, queue the processing request in a first queue in the control device, and acquire data corresponding to the processing request from the control device, and
the transmission device is further configured to request transfer of the data and the processing request to the processing device, and, prior to execution of the processing request in the processing device, queue the completion of processing of the processing request in a second queue in the control device and then release the queue of the completion of processing.

7. The transmission system according to claim 6, further including:
an other transmission device configured to transmit a signal between the transmission device and the processing device,
wherein the other transmission device is configured to include
a storage, and a controller,
the controller is configured to control a third queue in the processing device and a fourth queue in the processing device, and also control the storage,
the controller is configured to,
upon receiving a processing request and data transferred from the transmission device, store the received data in the storage, and
the controller is configured to queue the received processing request in the third queue, execute the processing request using the data stored in the storage in response to the processing request queued in the third queue, and, after executing the processing request, queue the completion of processing of the processing request in the fourth queue and then release the queue for the completion of processing.

8. The transmission system according to claim 7, wherein the controller is further configured to, upon detecting an error in the data related to the processing request, issue a reprocessing request to queue the reprocessing request in the third queue, read data from the storage or the transmission device in response to the reprocessing request queued in the third queue, execute the processing request using the read data, and, after executing the processing request, queue the completion of processing of the processing request in the fourth queue and then release the queue for the completion of processing.

9. The transmission system according to claim 1, wherein a plurality of the control devices is provided, and further including a higher-level device connected in parallel to the plurality of control devices and configured to transmit a higher-level command to each of the control devices in parallel;
each of the control devices is configured to,
upon receiving the higher-level command, issue a command and transmit the command to the processing device; and
the higher-level device is configured to,
upon receiving the completion of execution from all of the control devices, determine that execution for the higher-level command is complete.

10. The transmission system according to claim 1, wherein
a plurality of the control devices is provided, and further including a higher-level device connected in series to the plurality of control devices and configured to transmit a higher-level command to a first-in-line control device among the plurality of control devices connected in series;
the first-in-line control device is configured to,
upon receiving the higher-level command, issue the command, and upon receiving the completion of processing for the final processing request in the command, transmit the completion of execution to a subsequent-stage control device connected in series,
the subsequent-stage control device is configured to,
upon receiving the completion of execution from a preceding-stage control device connected in series, issue the command, and upon receiving the completion of processing for the final processing request in the command, transmit the completion of execution to a control device connected in series subsequent to the subsequent-stage control device;
the last-in-line control device connected in series is configured to,
upon receiving the completion of execution from the preceding-stage control device connected in series, issue the command, and upon receiving the completion of processing for the final processing request in the command, transmit the completion of execution to the higher-level device; and
the higher-level device, upon receiving the completion of execution from the last-in-line control device, determine that execution for the higher-level command is complete.

11. A transmission device comprising: a connection to a control device configured to issue a command including at least one processing request; and a connection to a processing device configured to execute respective processing corresponding to each processing request included in the command,
wherein the transmission device is configured to, when the processing corresponding to the processing request among a plurality of processing requests in the command is executed, receive completion of processing corresponding to the processing request from the processing device, and upon receiving completion of processing corresponding to a final processing request among the plurality of processing requests included in the command, notify the control device of the completion of execution for the command.

12. The transmission device according to claim 11, wherein the transmission device is further configured to, upon receiving the completion of processing for the processing request other than the final processing request, perform masking on the completion of execution for the command.

13. The transmission device according to claim 11, wherein the transmission device is further configured to count a number of times completion of processing corresponding to the processing request is received, determine whether the received count matches the number of processing requests in the command, and, when the received count matches the number of the processing requests, determine that the completion of processing for the final processing request is received.

14. The transmission device according to claim 11, wherein the processing device is further configured to,
upon executing the processing corresponding to the processing request among the plurality of processing requests in the command and notifying the transmission device of the completion of processing corresponding to the processing request, when the processing request is the final processing request, notify the transmission device of the completion of processing including an identifier indicating that the processing request is the final processing request, and, when the processing request is not the final processing request, notify the transmission device of the completion of processing including the identifier indicating that the processing request is not the final processing request, and
the transmission device is further configured to,
upon receiving the completion of processing from the processing device, determine whether the completion of processing is the final completion of processing based on the identifier indicating the completion of processing, and when the received completion of processing is the final completion of processing, notify the control device of the completion of execution of the command, and when the received completion of processing is not the final completion of processing, perform masking on the completion of execution to the control device.

15. The transmission device according to claim 11, wherein the transmission device is further configured to, upon notifying the processing device of the processing request in the command, determine whether the notified processing request is the final processing request, and when the notified processing request is not the final processing request, notify the control device of preliminary completion of the processing request, and when the notified processing request is the final processing request, perform masking on the preliminary completion of the processing request to the control device.
